(19) United States
(12) Patent Application Publication
(10) Pub. No.: US 2024/0200365 A1
(43) Pub. Date: Jun. 20, 2024

(54) LOCK

(71) Applicant: TNBT Holdings Pty Limited, Minchinbury (AU)

(72) Inventors: Simon BUTT, Minchinbury (AU); Ian BARTOS, Minchinbury (AU)

(21) Appl. No.: 18/542,075

(22) Filed: Dec. 15, 2023

(30) Foreign Application Priority Data
Dec. 15, 2022 (AU) 2022903859

(51) Int. Cl. E05B 63/14; E05B 9/02; E05B 15/02

(52) U.S. Cl. CPC E05B 63/14; E05B 9/02; E05B 15/0295

(57) ABSTRACT

A improved lock, preferably a latching deadbolting jimmy proof lock, includes a range of combinations of improvements for the provision of a latching deadbolt (not merely a manually driven bolt). The improved lock may have features including a latching lock capable of interacting with a strike from three door operating directions, latching with sensor moving, deadbolting being selectively auto-latching or manually driven, selectable exterior drive angles and forces and successful lock bolt throw indication.

### FIELD OF THE INVENTION

The present invention relates to locks for doors including doors opening inwards or opening outwards and sliding doors. It is particularly related to latching of such doors.

The invention has been developed primarily for use in/with domestic or office doors and will be described hereinafter with reference to this application. However, it will be appreciated that the invention is not limited to this particular field of use.

### BACKGROUND OF THE INVENTION

Locks usually come in one form or another. These forms can include:
a) A latching Lock usually has a latchbolt having an angled face that can ride over a strike lip and so ‘automatically’ lock into place when a door is closed. This ‘automatic’ feature is very convenient as the bolt doesn't have to be manually withdrawn when wanting to close the door. Higher security locks often include a deadlatch feature which locks the latchbolt so that it can't directly be pushed backwards into the lock out of the strike once it has extended into the strike.
b) A Deadbolted lock is one where the deadbolt is positively locked into position when it has entered the strike—that is you can't manually push the deadbolt out of the strike by pushing on the end of the bolt—they are solidly locked in place unless unlocked with their associated unlocking mechanism—they are dead.
   Deadbolting locks usually have Deadbolts with flat ends and so these can't ride over a strike when a door is closed like a latchbolt can so most deadbolts are manually entered into their strikes by the turning of a knob or key or moving a handle after a door is closed.
   A vertical deadbolt lock is of the form where the deadbolt or deadbolts vertically enter an enclosing horizontally extending strike.
c) A jimmy proof Lock is one where the combination of lock and strike geometry including the Lockbolt orientation arranges the lock and lockbolt to basically ‘intertwine’ with the strike and so when a door is shut it is not possible to prise the lock away from the strike and force the door open. A vertical deadbolt lock that has its deadbolt or deadbolts enter substantially enclosing circular formations integrally extending from a strike plate is jimmy proof as it is not possible to prise the lock away from the strike plate to thereby jimmy open the door. It is not that a jimmy bar can't get to the bolts—but that a jimmy bar can't separate the lock from the strike and so cannot prise the door apart from the jamb.

Meanings of terms used throughout this document may be found in the definitions part towards the end of the present specification under the heading ‘Interpretation’.

Each of the types of locks and their benefits and developments have progressed independently in each category of lock. There has been little synergistic developments across categories. Often the developments in one type of lock are to the detriment of another function that is a development of a different type of lock. The user must choose the lock type according to a main benefit they require and miss out on the benefits that other types of locks provide.

Locks are also limited by the type of door. Regardless of whether the door is hung by hinges on the right or left, or open inwards or open outwards, or is a sliding door, there is usually a totally separate lock or an adapter package to a lock that needs to be fitted to allow its single use.

Further, whether a lock is correctly used is important to the effective security that a lock is meant to provide. Often a misalignment or an obstruction accidentally or nefariously placed in the mechanism may render the lock not effectively latching or deadbolting. However there is usually no way of visually knowing this. In use, people often incorrectly think or presume they have securely locked the door when that is not the case.

It can be seen that known prior art improved locks have the problems of:
a) Limited versatility
b) Made for a single type of use
c) Limited security
d) Limited benefits with effective limitations
e) No visual indication of correct usage

The present invention seeks to provide an improved lock, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, an improved lock is provided by a latching deadbolting jimmy proof lock.

It can be seen that the invention of an improved lock provides the benefit of combining the benefits of having a deadbolting jimmy proof lock that is also latching.

According to a second aspect of the present invention, an improved lock is provided by a latching deadbolting jimmy proof lock that can be used in all three door operating directions, namely Open Inwards, Open Outwards and Lateral Sliding.

According to a third aspect of the present invention, an improved lock is provided by making use of the lock straightforward without the need for a user to retain the bolts retracted by keeping the key or knob turned during the door opening operation.

According to a fourth aspect of the present invention, an improved lock is provided by a deadbolting jimmy proof lock that can be used as both latching and manually driven in one product.

A latching deadbolting lock has the deadbolt sprung into its strike. However, if and when the spring hasn't sufficiently thrown the bolt into the strike, caused by for example the strike not aligning correctly with bolt/s thereby failing to enter the strike by spring force, the improved lock of the present invention can change to direct drive and manually drive the bolt/s in. This improvement provides a product that can be set to work both ‘automatically’ with the bolt being sprung into the strike but also alternately with the bolt being manually driven by hand.

According to a fifth aspect of the present invention, an improved lock is provided which is desirable such that the new lock is key operable at a low operation force and handle operable at a low rotation angle.

According to a sixth aspect of the present invention, an improved lock is provided with an indicator of the bolt having been sufficiently thrown and hence deadbolted whereby a user can be assured of correct, successfully and effective latching of the jimmy proof deadbolting lock.

Therefore the invention provides a range of combinations of improvements including:
a) Improvement 1—latching deadbolt—not merely a manually driven bolt
b) Improvement 2—latching lock—capable of interacting with a strike from all 3 door operating directions
c) Improvement 3—latching with sensor moving—and moving in one direction only
d) Improvement 4—deadbolt being selectively auto-latching or manually driven
e) Improvement 5—selectable exterior drive angles and forces
f) Improvement 6—successful lock bolt throw indication

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIGS. 1 to 3 are views in accordance with a preferred embodiment of the present invention;

FIG. 4 is an exploded view of a lock in accordance with one embodiment having a plurality of the improvements in a synergistic way;

FIG. 5 is a diagrammatic open rear view of the assembled lock of FIG. 4;

FIGS. 6 to 9 are diagrammatic overhead views of the operative latching deadbolting jimmy proof lock

FIGS. 10 and 11 are diagrammatic front views without and with sectional cut out of strike showing the latching operation in a particular combination version of improvements of the lock;

Each pair of FIGS. 12 and 13, FIGS. 14 and 15, FIGS. 16 and 17, FIGS. 18 and 19, FIGS. 20 and 21, FIGS. 22 and 23, and FIGS. 24 and 25 and FIGS. 26 and 27 are front operative views and corresponding rear open back views of the interior of the lock showing component part positions in that operative position; note that the intermediate mechanical assembly shown in FIG. 75 is not shown here in these drawings for clarity;

FIGS. 28 to 33 are diagrammatic perspective views and operative overhead views of an improved lock providing a latching deadbolting jimmy proof lock that can be used in an opening inward door operating direction.

FIGS. 34 and FIGS. 35 to 39 are diagrammatic perspective views and operative overhead views of an improved lock providing a latching deadbolting jimmy proof lock that can be used in an opening outward door operating direction.

FIGS. 40 and FIGS. 41 to 45 are diagrammatic perspective view and operative overhead views of an improved lock providing a latching deadbolting jimmy proof lock that can be used in an opening inline sliding door operating direction.

Each pair of FIGS. 46 and 47, FIGS. 48 and 49, FIGS. 50 and 51, FIGS. 52 and 53, FIGS. 54 and 55, FIGS. 56 and 57 and FIGS. 58 and 59 are rear open back views showing component part positions in an operative position and corresponding front operative views.

FIG. 60 is a detailed view of an improved lock which in one product provides a deadbolting jimmy proof lock that can be used as both automatically latching or reconfigured for manually driven;

Each pair of FIGS. 61 and 62, FIGS. 63 and 64, FIGS. 65 and 66, FIGS. 67 and 68, and FIGS. 69 and 70 are rear open back views showing component part positions in an operative position and corresponding front operative views of the improved lock of FIG. 60.

FIGS. 71 to 96 are exploded views showing the new lock which is both key operable at a high rotation angle and handle operable at a low rotation angle; and

FIGS. 97 to 102 are diagrammatic operative views showing a latching jimmy proof deadbolting high security lock that a user can be assured has sufficiently thrown bolts and is deadbolted.

### DESCRIPTION OF PREFERRED EMBODIMENTS

It should be noted in the following description that like or the same reference numerals in different embodiments denote the same or similar features.

The present invention provides a versatile lock that can include one or more of the improvements in a synergistic way selected from:
a) a latching deadbolt;
b) a latching lock able to engage doors operating as hinging outward, hinging inward or sliding parallel;
c) staying unlatched until closing again;
d) deadbolt being selectively latching or driven;
e) selective gear rotational drive; and
f) successful lock bolt throw indication.

### Improvement 1—Latching Deadbolt—not Merely a Manually Driven Bolt

The present invention in one form provides a latching deadbolt. That is a deadbolt lock where the deadbolt is positively locked into position when it has entered the strike. However, the deadbolt is further activated by a latching lock in which a strike is engaged and automatically locks into place when a door is shut. It is not possible to manually push the deadlock out of the strike by pushing on the end of the bolt as they are solidly locked in place unless unlocked with their associated unlocking mechanism.

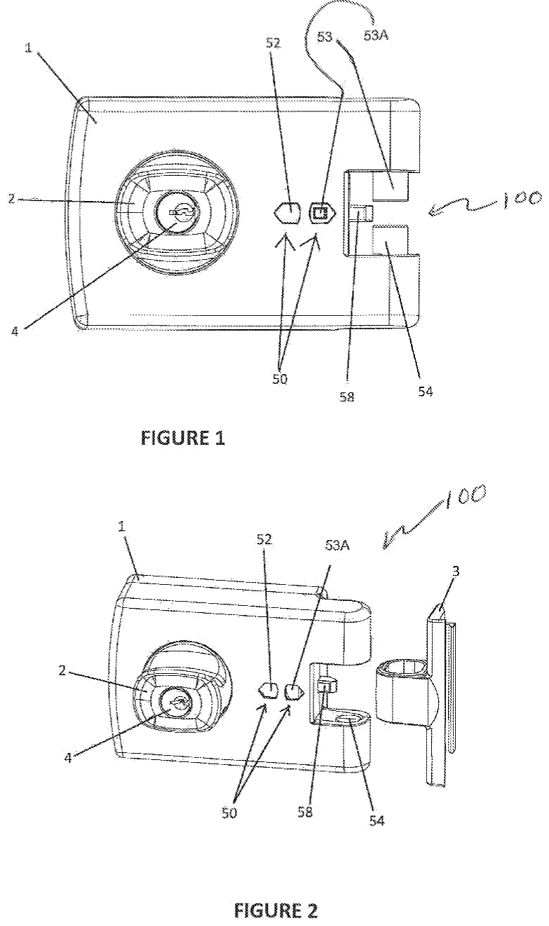

In a particular embodiment as shown in FIGS. 1 to 3, lock 100 includes a case 1, a pair of opposingly moveable bolts 53 & 54, a closing spring member 48, an operator 2, a latching member 61, and a door closing sensor button 58.

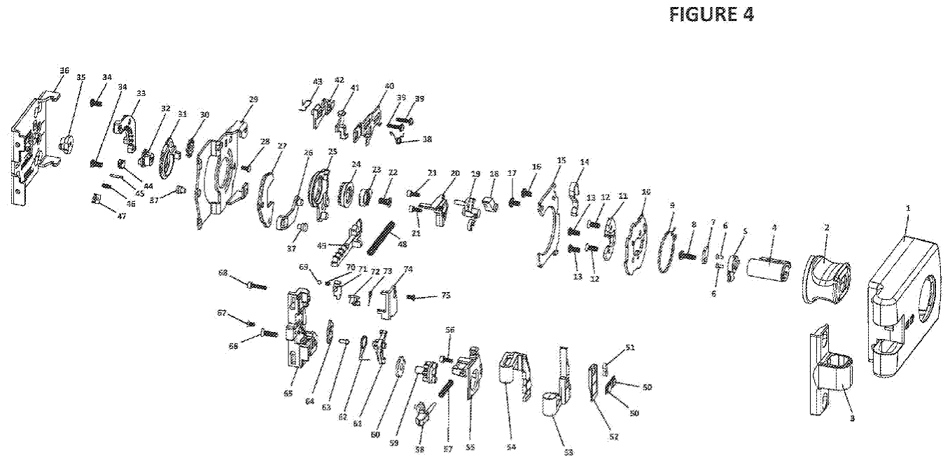

In such an embodiment, the lock 100 has the pair of opposingly moveable bolts 53, 54, co-linearly mounted in the case 1 and slidably mounted providing relative linear motion to protrude into a lock space from opposing top and bottom sections of the case. The closing spring member 48 (see FIGS. 4 & 5) urges the bolts 53, 54 to protrude in a pincer movement from opposing top and bottom sections of the case 1 into a door secured position. In this embodiment, the operator is the form of a door knob 2 having an inner cylinder 4 with the keyhole. The inner cylinder 4 allows or prevents rotation of operator 2. Rotation of operator 2 causes relative linear motion of the bolts 53 & 54 towards each other between closed and open positions, respectively. It should be noted that the knob 2 is designed to drive the bolts 53 & 54 towards each other in the direct drive mode. Whereas in latching mode, the spring member 48 has the function of driving the rotating member 59/60 which in turn drives the bolts 53 and 54 towards each other.

The bolts 53 & 54 are sprung to extend but can be held retracted inside the lock case 1 by a latching member 61. As the bolts 53 & 54 do not ride over the strike 3 and then engage as a latchbolt would, there is included an extra sensing button 58 (which may take the form of a pin) that is depressed upon the approach of the strike 3 as the door (not shown) is closed and releases the latching member 61 holding the bolts 53 & 54 which are then sprung extended into the strike 3.

The latch member 61 is capable of engaging rotating member 59/60 and is positioned to engage and hold rotating member 59/60 in a position where the bolts 53 & 54 are retained being withdrawn away from each other and out of the lock space to a door unsecured position at a time when the rotating member 59/60 has been rotated by the action of rotating member 2. At this time, the door closing sensor button 58 can be engaged by the strike 3 so as to cause ingress of the door closing sensor 58 into the body of the lock. This consequentially drives the latch member 61 resulting in unlatching of the rotating member 59/60 and allowing the closing spring member 48 to return the bolts 53 & 54 to the door secured position. At this time, the rotational position of the rotating member 59/60 and the geometry of its connection with bolts 53 & 54 ensures that bolts 53 & 54 are deadbolted in this door secured position.

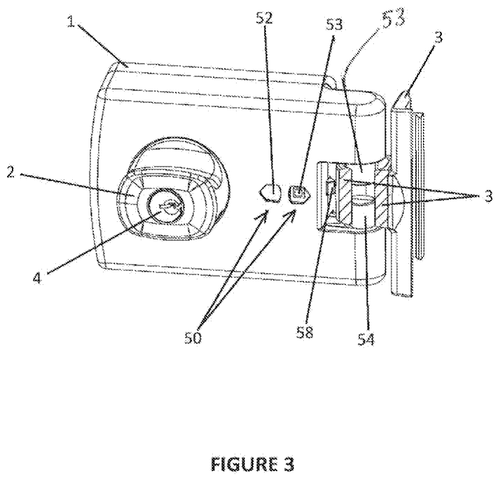

It can be seen in FIG. 2 and by cutaway in FIG. 3 that the two sliding opposing bolts 53 & 54 can extend into a circular portion of the strike 3 in a pincer movement completely encased by the circular part of the strike 3. As such, by not providing access to the bolts 53 & 54, particularly with no access to the spacing between the bolts, the lock becomes jimmy proof. It can be understood that the strike 3 does not require a substantially enclosing circle but sufficient shaping is required to restrict jimmy access so that one cannot jimmy to separate the lock from the strike 3 and hence the door cannot be prised apart from the jamb.

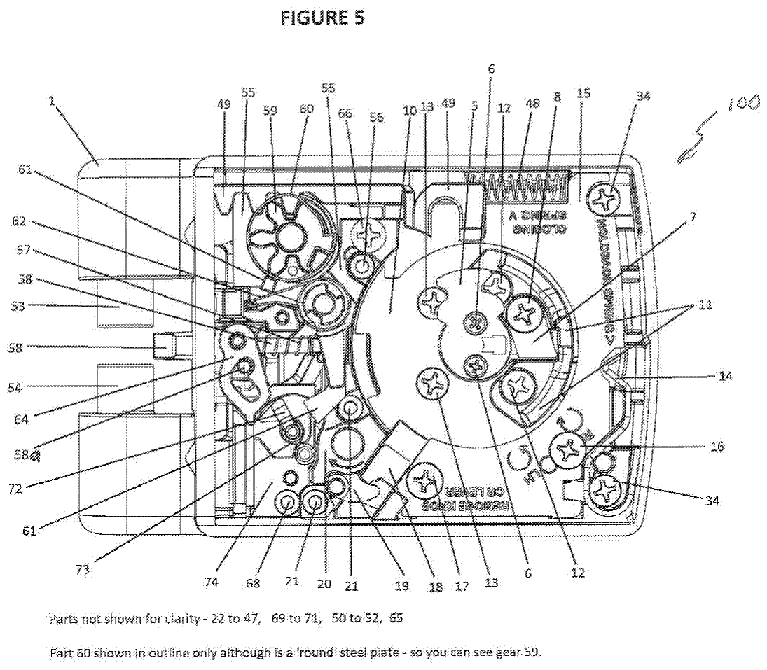

Referring to FIGS. 4 and 5, there is an exploded view of a latching deadbolt in accordance with an embodiment of the present invention with a number of the concepts synergistically working together. Further, there is a constructed version. The following parts listing is of this embodiment. Parts of the construction will be separately described and can include some but not all of these parts in various embodiments of the present invention.

| | | | |
|---|---|---|---|
| 1 | Case | 39 | Slide Screw |
| 2 | Knob (operator) | 40 | Slide |
| 3 | strike | 41 | Slide Interlock |
| 4 | Inner Cylinder | 42 | Slide Base |
| 5 | Inner Cylinder Cam | 43 | Slide Detent Spring |
| 6 | Inner Cylinder Cam Screw | 44 | Overcentre Spring Bearing |
| 7 | Inner Cylinder Retainer | 45 | Overcentre Detent (ie. Overcentre Spring Guide) |
| 8 | Inner Cylinder Retainer | 46 | Overcentre Spring |
| | Screw | | |
| 9 | knob (centralising) Spring | 47 | Overcentre Spring Seat |
| 10 | knob drive Plate | 48 | closing Spring member |
| 11 | knob driving boss (ie. | 49 | drive Rack |
| | knob drive) | | |
| 12 | drive Screw | 50 | Indication Window |
| 13 | knob drive Plate Screw | 51 | Deadlock Indicator drive Link |
| 14 | Holdback Spring | 52 | Deadlock Indicator |
| 15 | Retaining Plate | 53 | bolt |
| | | 53A | bolt Throw Indicator |
| 16 | Direction Setting (Stop) | 54 | bolt |
| | Screw | | |
| 17 | Retaining Plate Screw | 55 | drive gear Bearing |
| 18 | Lock Pawl | 56 | drive gear Bearing Screw |
| 19 | Lock Pawl drive | 57 | door closing sensor Spring |
| 20 | Lock Pawl drive Bearing | 58 | door closing sensor (button) |
| | | 58a | door closing sensor drive pin (ie. sensing pin) |
| 21 | Lock Pawl drive Bearing | 59 | bolt drive gear (part of rotating member) |
| | Screw | | |
| 22 | Outer Cylinder Cam | 60 | drive gear Top (part of rotating member) |
| | Screw | | |
| 23 | Outer Cylinder Cam | 61 | latching member (ie. latch), comprising: |
| | | 61a | Latch heel; and |
| | | 61b | latch hook |
| 24 | Drive gear (ie. Epi Inner | 62 | latch spring (also referred to as latch hook spring) |
| | gear) | | |
| 25 | drive Arm | 63 | door closing drive (Link) Pin |
| 26 | drive Link Clockwise | 64 | door closing drive Link (ie. first latch drive lever) |
| 27 | drive Arm Clockwise | 65 | latch Mechanism Housing |
| 28 | Epi Outer gear screw | 66 | latch Mechanism Housing Screw 1 |
| 29 | Mechanism Plate | 67 | latch Mechanism Housing Screw 2 |
| 30 | Epi Idler gear | 68 | latch Mechanism Housing Screw 3 |
| 31 | Epi gear drive | 69 | Detent Ball |
| 164 | Boss B | | |
| 31B | Boss C | 160 | Boss D |
| 32 | Outer cylinder drive | 70 | Detent Ball Spring |
| 33 | Fixed gear (ie. Epi outer | 71 | Function Selector (ie. latch disable switch) |
| | gear) | | |
| 34 | Mechanism Plate Screw | 72 | latch Hook driver (ie. second latch drive lever) |
| 35 | Drive Connector (ie. | 73 | latch Hook driver Spring |
| | Turntail Coupling) | | |
| 35a | Alternate shaped drive | | |
| | connector | | |
| 102 | door jamb | | |
| 100 | lock | 101 | door |
| 36 | Mounting Plate | 74 | Function Selector Housing |
| 37 | Clockwise drive Boss | 75 | Function Selector Housing Screw |
| 38 | Slide Interlock Spring | 80 | Boss 1 |
| 158 | Idler gear carriage | 81 | Boss 2 |
| 150 | Slot | 162 | Bolt drive rack connection |
| 156 | Axle | 100 | Lock |
| 154 | Face A | 152 | Drive connector Face B |

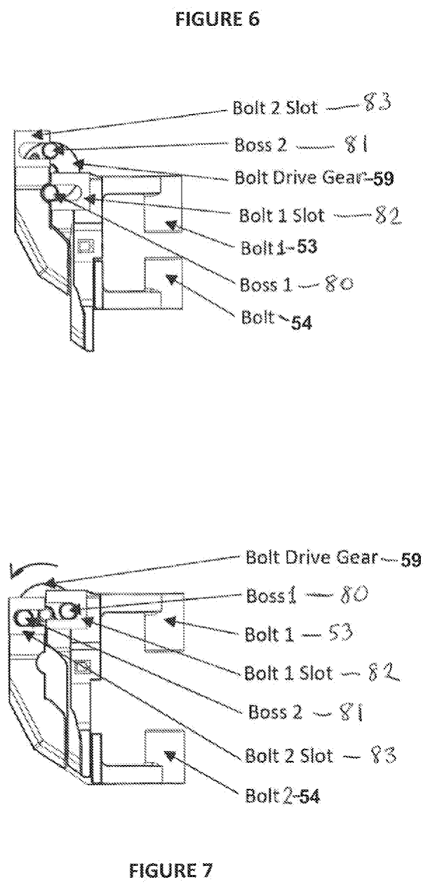

As shown in FIGS. 6 to 9, the bolts 53 & 54 are automatically deadbolted in place at the extreme of extension by the geometry of their connection to a bolt drivegear 59.

The pair of opposingly moveable bolts 53, 54 are co-linearly and slidably mounted in the case 1 providing relative linear motion to protrude into a lock space from opposing sections of the case 1. The closing spring member 48 urges the bolts 53 & 54 to protrude in a pincer movement from the opposing sections of the case 1 into the lock space to a door secured position within the enclosing ring of the strike 3.

Referring to FIGS. 12 to 27, the bolt drive gear 59 engages at least one or both bolts 53, 54 with the rotation of the bolt drive gear 59 causing relative linear motion of the bolts 53 & 54 to substantially withdraw the bolts 53 & 54 from the lock space and the latching member 61 is positioned to engage the rotating member 60/59 (which includes the coupled drive gear top 60 and bolt drive gear 59), in a latched position when the drive gear top 60 (and hence the coupled bolt drive gear 59) is so rotated to withdraw the bolts from the lock space to a door unsecured position.

The door closing sensor button 58 is configured to protrude from the case 1 and sense the relative location of the strike 3. Based on the sensed relative location of the strike 3, the door closing sensor button 58 is designed to drive the latching member 61 to unlatch the rotating member 59/60 thereby allowing the closing spring member 48 to cause the bolts 53 & 54 to protrude back into the lock space within the enclosing ring of the strike 3 thereby resulting in the door secured position.

In this embodiment, the door closing sensor button 58 includes a mechanical engaging sensor. This includes a suitably shaped surface engageable with a strike which physically engages in the lock space.

In another form, the door closing sensor button 58 includes an electronic engaging sensor and a positional sensor capable of sensing the relative location of the strike extending into the lock space.

The Bolt Drive Gear 59 is associated with the rotatable knob 2. Often the rotatable knob 2 includes a cylinder lock to form a keyed rotatable knob.

The benefits of the new latching deadbolt include the ability to manufacture, stock and sell one product with many functions and the economies of scale.

FIG. 1 shows the lock 100 being at rest, bolts being extended, the door closing sensor being extended and the strike not contacting the lock.

FIG. 2 shows that the knob has been turned to retract the bolts 53 & 54 which have internally been latched retracted. (Note that this latching is not the latching locking function where the bolts 53 & 54 latch into the strike). The knob 2 has then been released and has re-centred. The door closing sensor button 58 is still extended.

Referring to FIG. 3, the door is now in a closed state and the lock has approached the strike 3. The strike 3 has been sectioned here for clear viewing. The strike 3 enters the lock space between the retracted bolts 53 & 54 and has pressed the door closing sensor button 58 back into the lock case 1. This has unlatched the bolts 53 & 54 from their retracted position, and they have sprung extended to enter the cavity in the strike 3. As a result, the lock is now prevented from being jimmied away from the strike 3.

The above described movement of the sprung bolts 53 & 54 being urged into the strike is what is meant by the description of latching lock.

When the bolts 53 & 54 are sufficiently extended, they are also deadbolted by the mechanism geometry—that function will be described next with reference to the accompanying FIGS. 6 to 9.

FIG. 6 shows the internal arrangement of the bolts 53 & 54 and the bolt drive gear 59 shown without the lock case 1. The bolt drive gear 59 has a boss 80, 81 travelling in a slot 82, 83 in each bolt 53, 54. As the bolt drive gear 59 rotates, each boss 80, 81 drives its respective bolt 53, 54 in the opposite direction. As shown here with the bolts 53 & 54 closed, the bosses 80 & 81 function to deadbolt the respective bolts 53 & 54 from any movement as the bosses 80 & 81 both lie on a line sufficiently parallel with the sliding direction of the bolts 53 & 54.

FIG. 7 shows the bolt drive gear 59 has rotated just over a quarter turn anti-clockwise and its bosses 80, 81 have caused the bolts 53 & 54 to move just over half their linear travel. The bolts 53 & 54 here are not deadbolted. Pressure on the bolts 53 & 54 could cause the bolt drive gear 59 to rotate and allow the bolts 53 & 54 to move.

FIG. 8 shows the bolt drive gear 59 has now rotated a full half turn anti-clockwise and its bosses 80 & 81 have caused the bolts 53 & 54 to travel their full distance and are now fully apart and withdrawn from a strike 3. Although not required in the open position, as shown here, the bosses 80 & 81 deadbolt the bolts 53 & 54 from any movement as the bosses 80 & 81 both lie on a line sufficiently parallel with the sliding direction of the bolts 53 & 54.

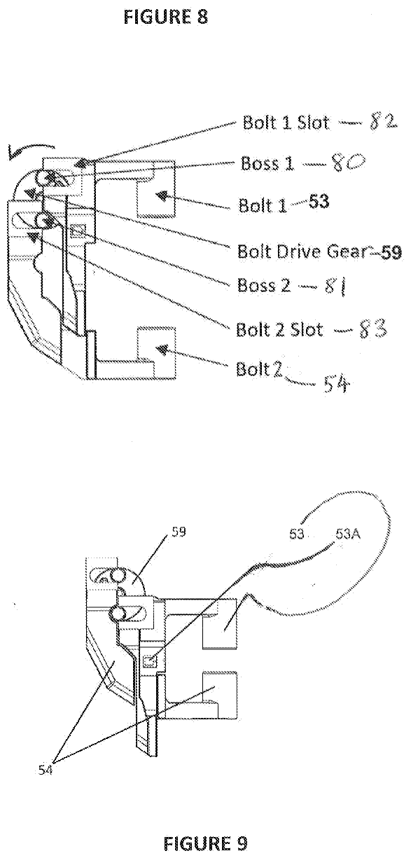

FIG. 9 shows half turn rotation of the bolt drive gear 59 which returns to the position shown in FIG. 6.

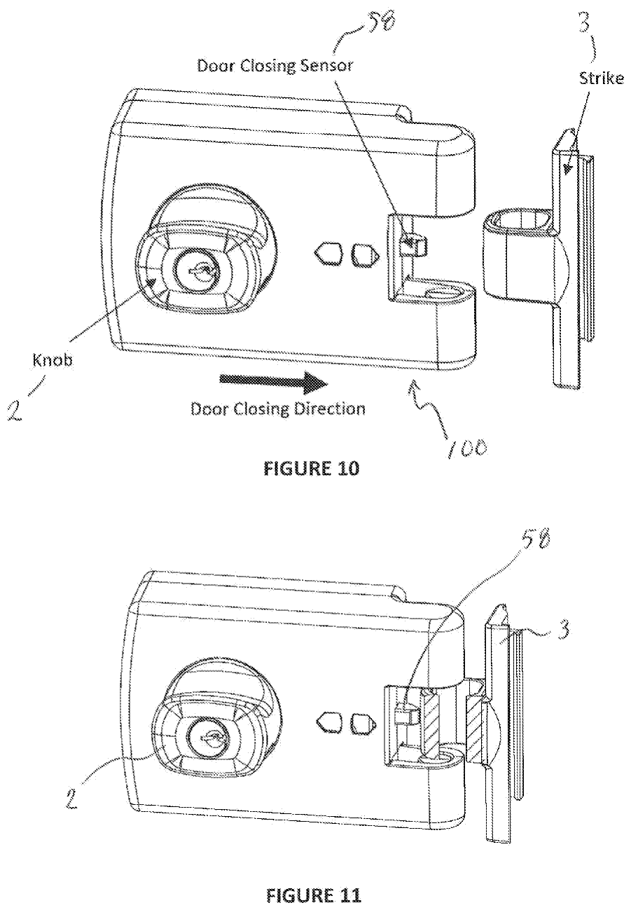

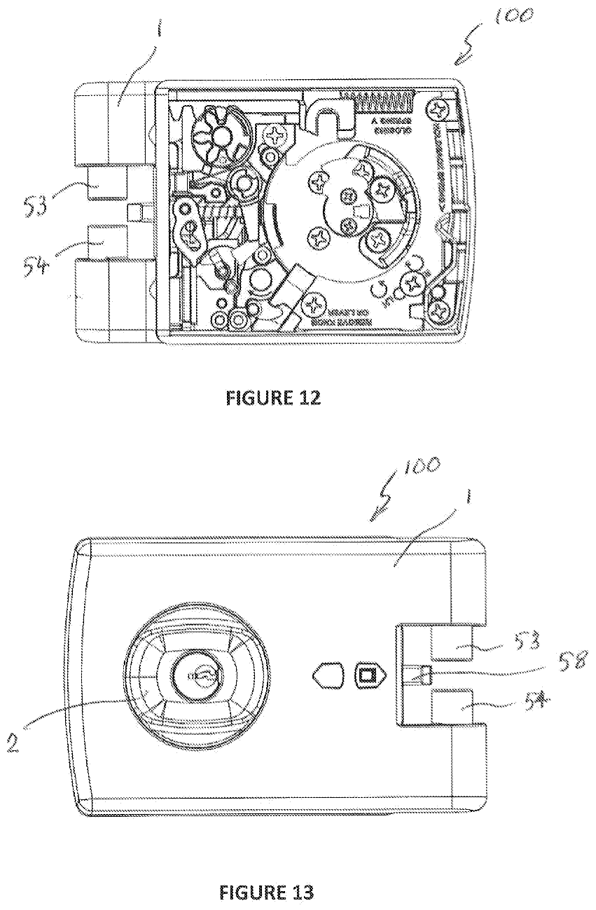

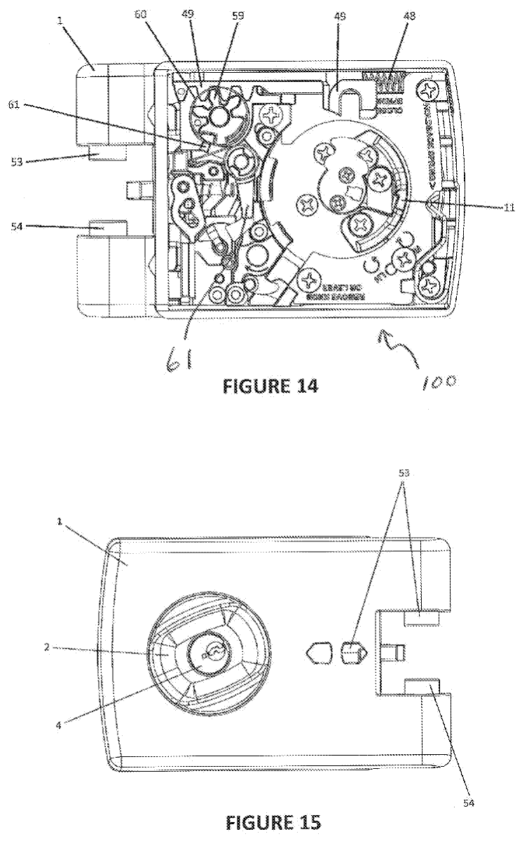

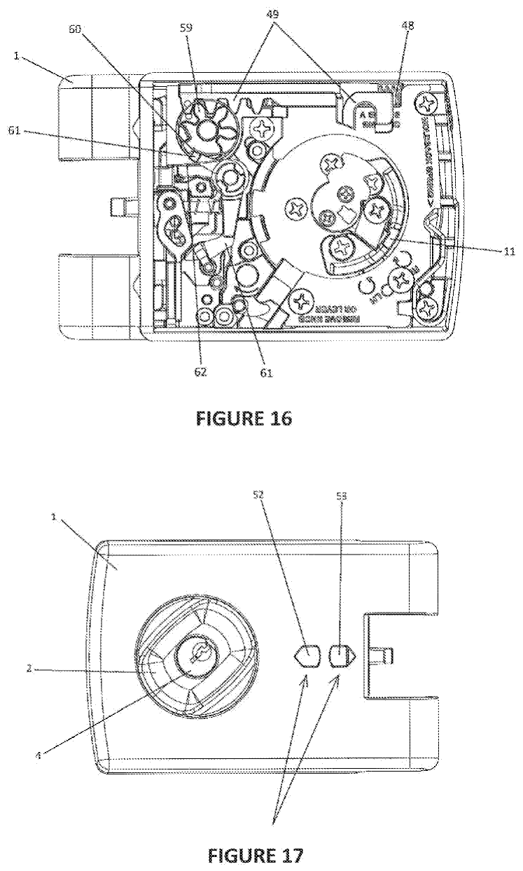

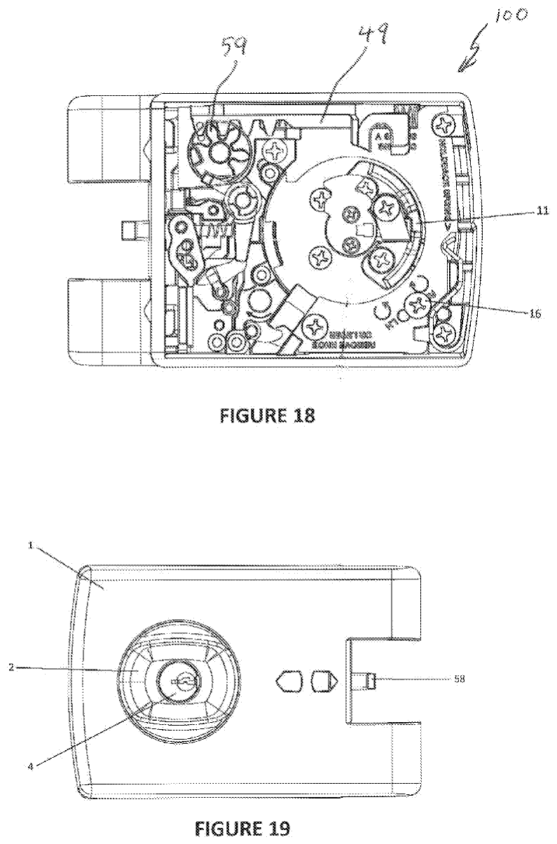

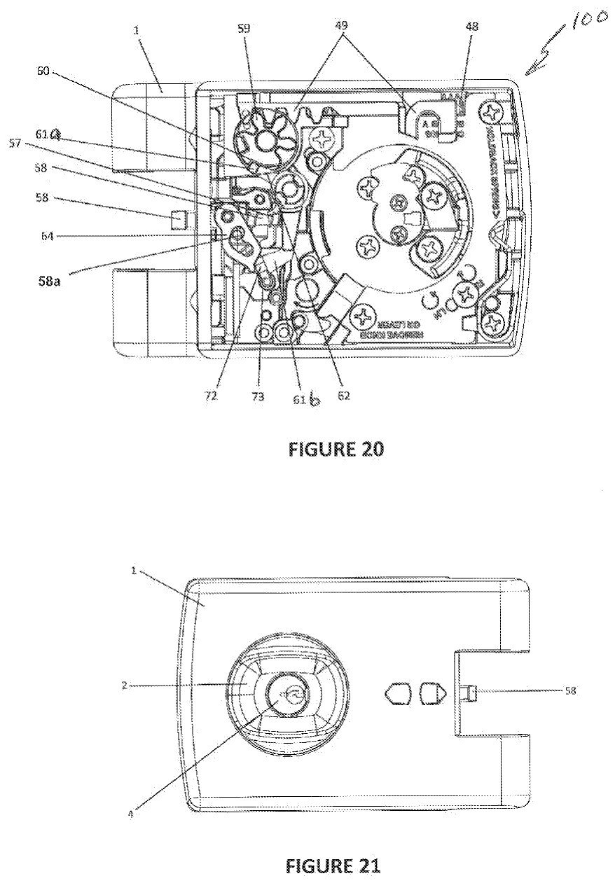

FIGS. 10 and 11 show the lock 100 engaging the strike 3 as the door (on which the lock 100 is mounted when in use) closes.

These show a basic door closing movement and operation of the lock 100.

FIGS. 12 and 13 show the lock at rest. In use, the lock starts at rest with bolts 53 & 54 extended, knob 2 central, door closing sensor 58 extended, lock mechanism set up as a latching lock—not direct driven.

FIGS. 14 and 15 show the interior and exterior of the lock 100 when the knob 2 is turned—bolts 53 & 54 half retracted.

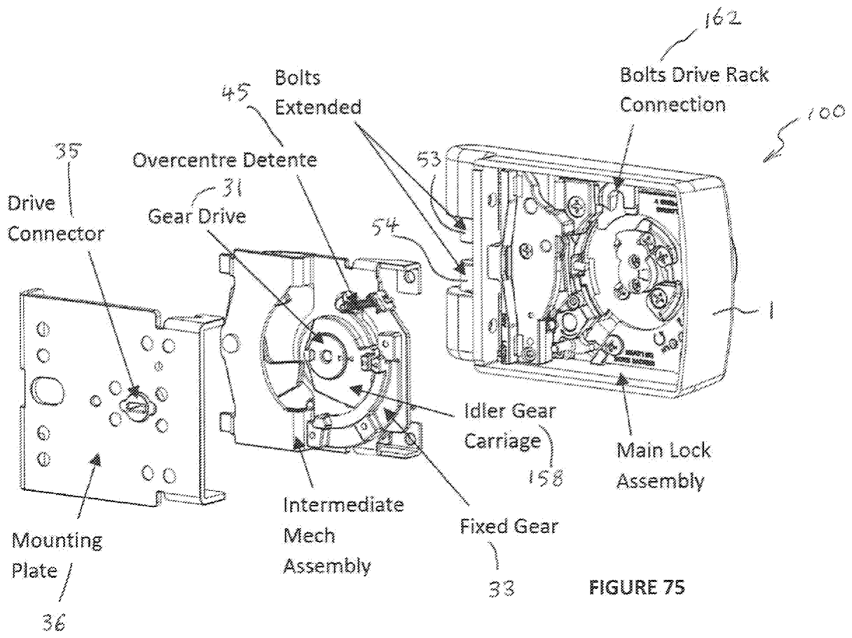

The knob 2 is half turned anti clockwise (anticlockwise) looking from the outside (as shown in FIG. 15). The knob driving boss 11 (see FIG. 14) connected through bolt drive rack connection 162 (with interconnecting mechanism not shown here—in this regard, refer to the relevant description below for FIG. 75) is designed to withdraw the drive rack 49 to the right (compressing and charging the closing spring member 48) thereby rotating the bolt drive gear 59 clockwise as shown in FIG. 14 (which has two locating pins one connecting with each bolt). This results in retracting both bolts into the lock case 1. As the knob has rotated, this motion has charged a knob centralising spring 9 (not shown here).

FIGS. 16 and 17 show the interior and exterior of the lock 100 when the knob is fully turned which results in the bolts 53 & 54 being fully retracted and latched open.

The knob is turned fully anticlockwise (looking from the outside as shown in FIG. 17) and the knob driving boss 11 connected through the bolt drive rack connection 162 (with interconnecting mechanism including lost motion not shown here) withdraws the drive rack 49 fully to the right (compressing the closing spring member 48 fully) thereby rotating the bolt drive gear 59 fully clockwise as shown in FIG. 16 (which has 2 locating pins one connecting with each bolt). This results in retracting both bolts fully into the lock case 1. The latch 61 has rotated clockwise as shown in FIG. 17 under the influence of the latch spring 62 and the latch heel 61a has moved into a recess in the bolt drive gear 59 now locking this gear 59 from rotating back anticlockwise as illustrated in FIG. 16 (as would be driven by the charged closing spring member 48). This results in retaining of the bolts retracted. As the knob 2 rotates further, this motion further charges a knob centralising spring 9 which is not shown.

FIGS. 18 and 19 show the interior and exterior of the lock 100 when the bolts are fully retracted, latched open, and the knob 2 back to central.

The knob 2 is released and re-turned central clockwise (looking from the outside as shown in FIG. 19) through the urging of the charged knob centralising spring 9 not shown. The knob 2 comes to rest neutrally sprung against the knob direction setting screw 16 which prevents further movement past the central position. With the knob's interconnecting mechanism including lost motion between the knob driving boss 11 and the bolt drive rack connection 162, no other effect is had in the lock 100. The bolts 53 & 54 are now withdrawn but charged ready to be sprung extended.

FIGS. 20 and 21 show the interior and exterior of the lock 100 when the door (not shown) is open but just starting to close on the strike 3 prompting initial movement of the door closing sensor (58).

The tip of the door closing sensor 58 contacts the lock strike (not shown) as the door is being closed. The door closing sensor 58 starts to be depressed into the lock case 1 against the door closing sensor spring 57. The door closing sensor drive pin 58a starts to act upon the first latch drive lever 64 which rotates anticlockwise as shown in FIG. 20. This in turn contacts the second latch drive lever 72 which rotates clockwise as illustrated in FIG. 20 until it contacts the latch drive (ie. latch hook) 61b of the latching member 61.

FIGS. 22 and 23 show the interior and exterior of the lock 100 when the door (not shown) is closing further—door closing sensor 58 has unlatched the bolts 53 & 54.

The door is closed further and the door closing sensor 58 continues moving right further into the lock case 1 and hence compressing the door closing sensor spring 57 further. The door closing sensor drive pin 58a rotates the first latch drive lever 64. Subsequently the second latch drive lever 72 rotates clockwise which then acts upon the latch drive (ie. latch hook) 61b thereby rotating the latch itself anticlockwise as illustrated in FIG. 22 against the urging of the latch spring 73. This last movement withdraws the latch heel 61a from engagement with the recess on the bolt drive gear 59 leaving it free to rotate anticlockwise under the urging of the closing spring 57 acting through the drive rack 49, as illustrated in FIG. 22.

FIGS. 24 and 25 show the interior and exterior of the lock 100 when fully extended with bolts 53 & 54 extended and deadbolted.

The bolt drive gear 59 rotates anticlockwise (as shown in FIG. 24) under the urging of the closing spring member 48 driving through the drive rack 49. The two bolts 53 & 54 extend fully and engage into the strike 3 (not shown). The door closing sensor 58 remains depressed by the strike 3 (not shown).

FIGS. 26 and 27 show the interior and exterior of the lock 100 when the bolts 53 & 54 are fully retracted and the door being ajar—door closing sensor 58 no longer depressed.

To complete the cycle, the lock 100 is returned to the original condition as shown in FIG. 26 by retracting the bolts 53 & 54 and opening the door (not shown). The knob 2 is turned fully anticlockwise (looking from the outside as shown in FIG. 27) withdrawing the drive rack 49 fully to the right thereby rotating the bolt drive gear 59 fully clockwise (as illustrated in FIG. 26) which in turn retracts both bolts 53 & 54 fully into the lock case 1. The latching member 61 has rotated clockwise with the latch heel 61a locking this gear 59 from rotating back anticlockwise as illustrated in FIG. 26 (as would be driven by the charged closing spring member 48) and the bolts retracted are retained as a result. As the knob 2 was rotated anticlockwise, this motion charged a knob centralising spring (not shown). After the bolts 53 & 54 are retracted and the knob 2 released, this charged spring urges the knob 2 back to its central/neutral position.

A number of variations in functionality will be outlined later. The combination of components and functionality discussed here are pretty much dedicated to making a latching, jimmy proof, deadbolting lock. It could however just as easily be used to provide a latching deadbolting lock—without being jimmy proof, or even possibly a latching multi-point locking system.

Improvement 2—Latching Lock Capable of Interacting with a Strike from all 3 Door Operating Directions

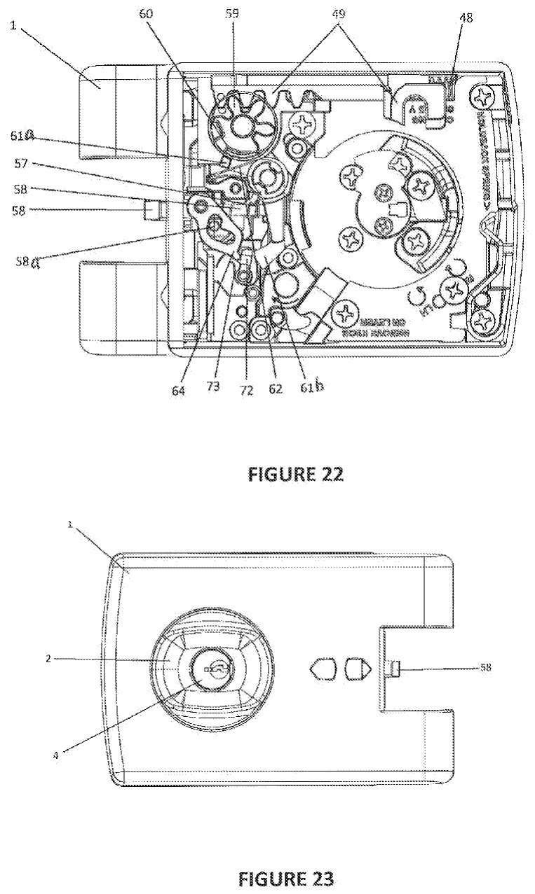

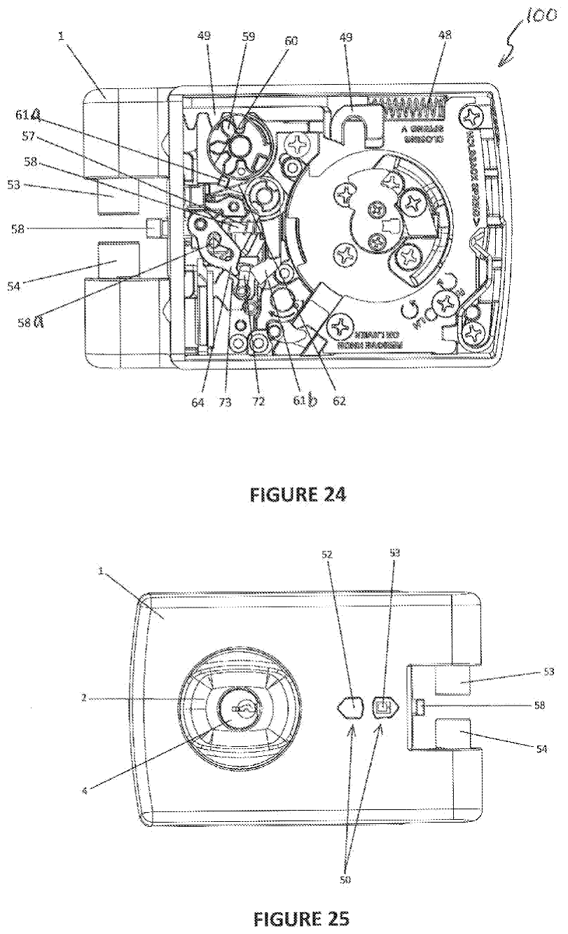

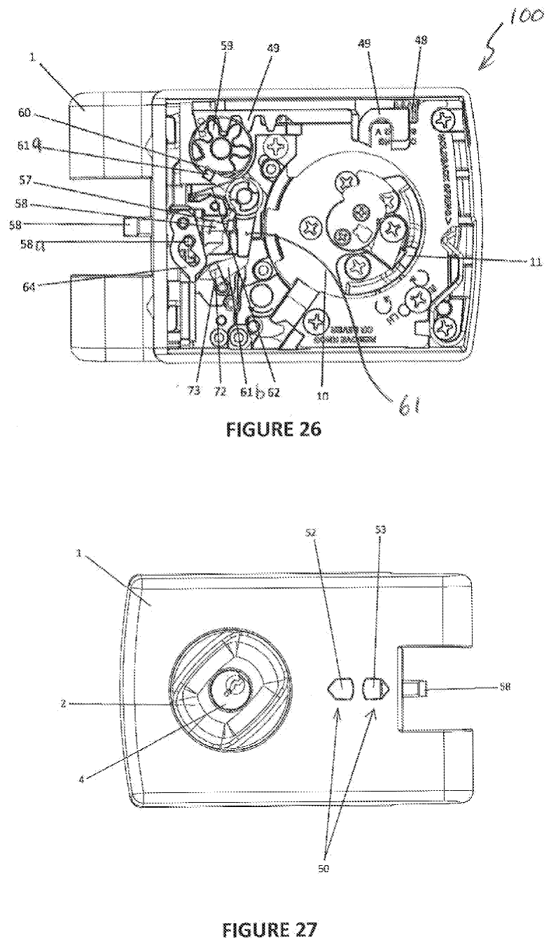

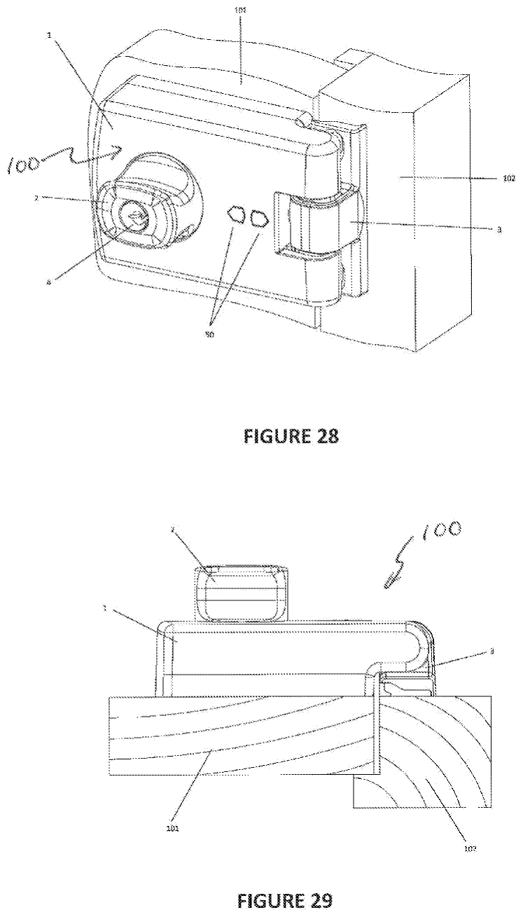

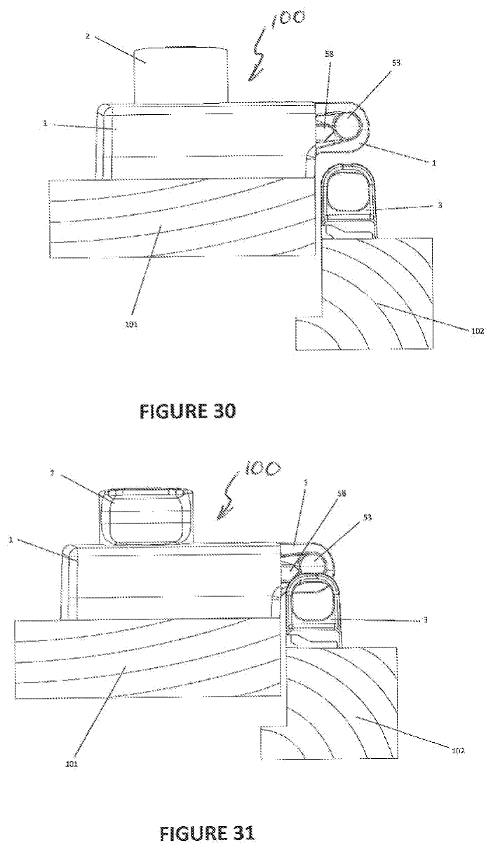

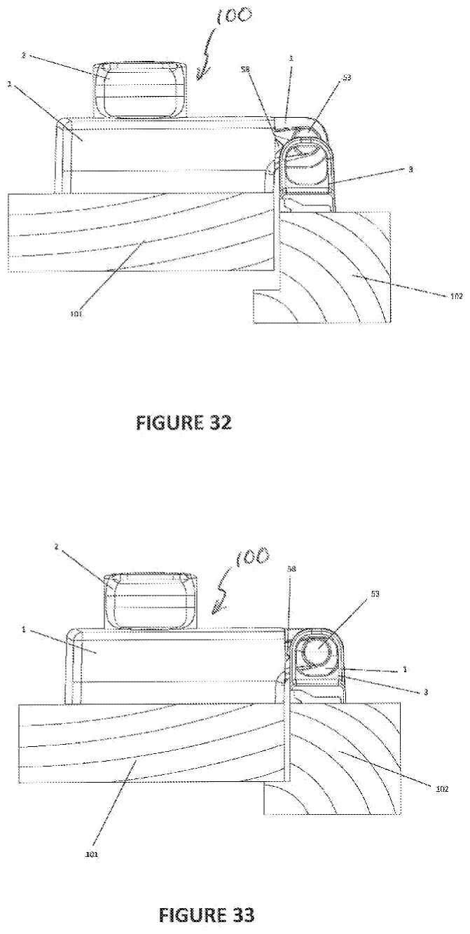

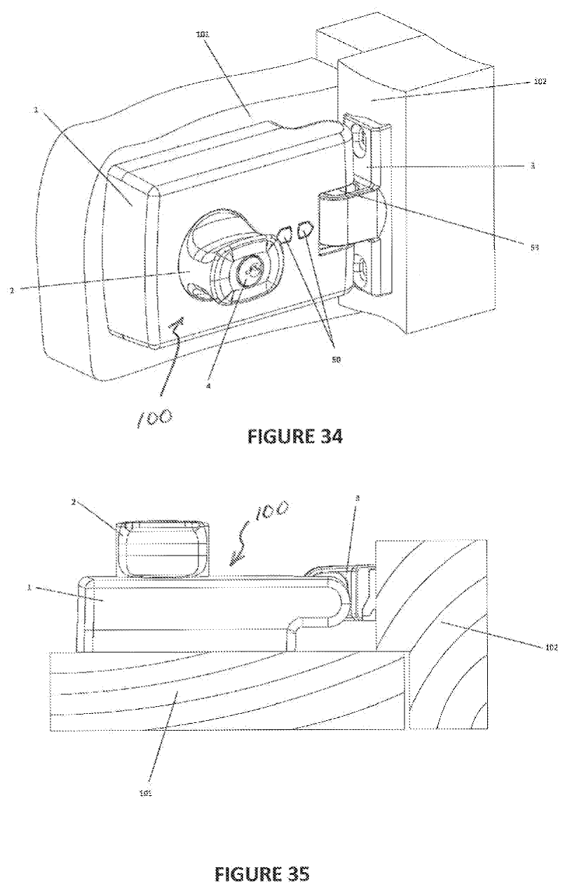

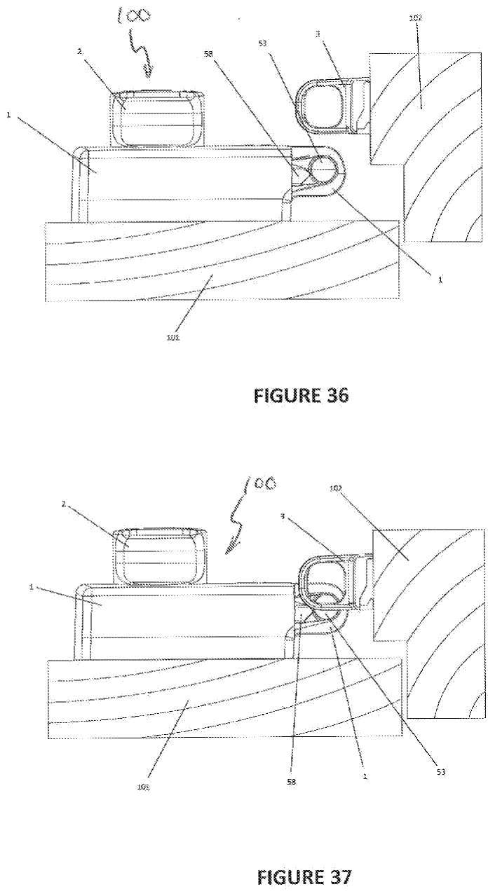

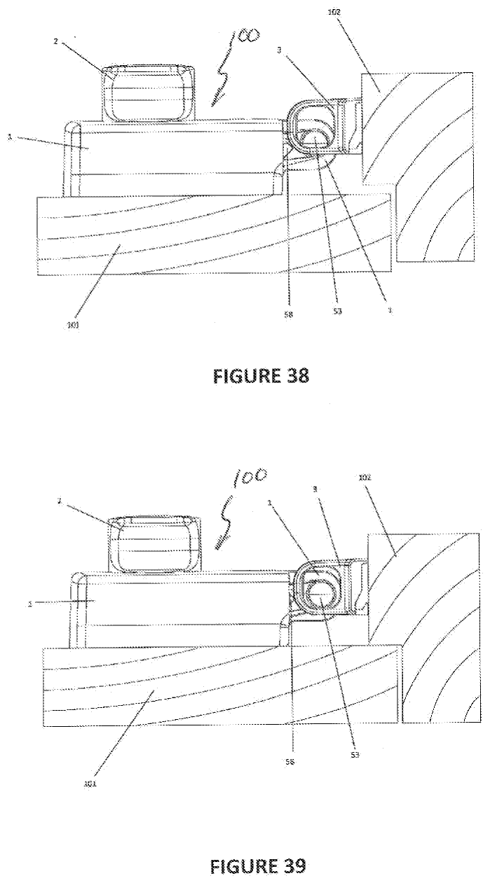

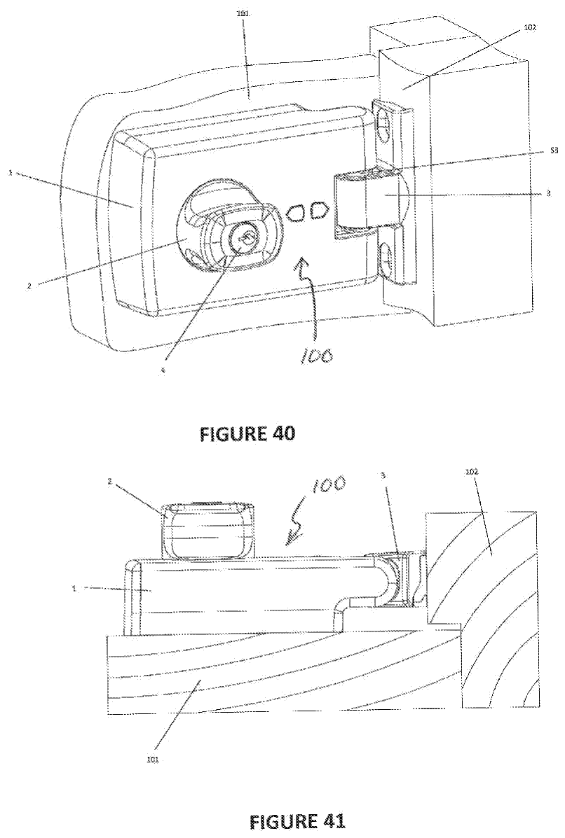

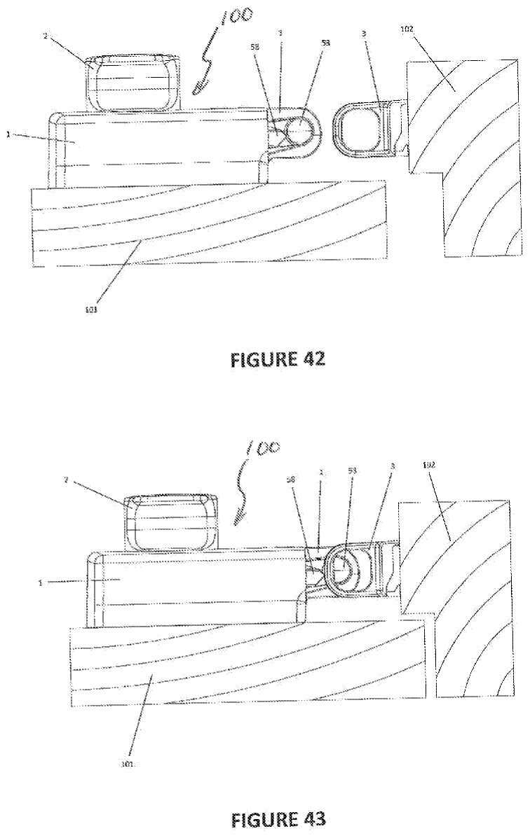

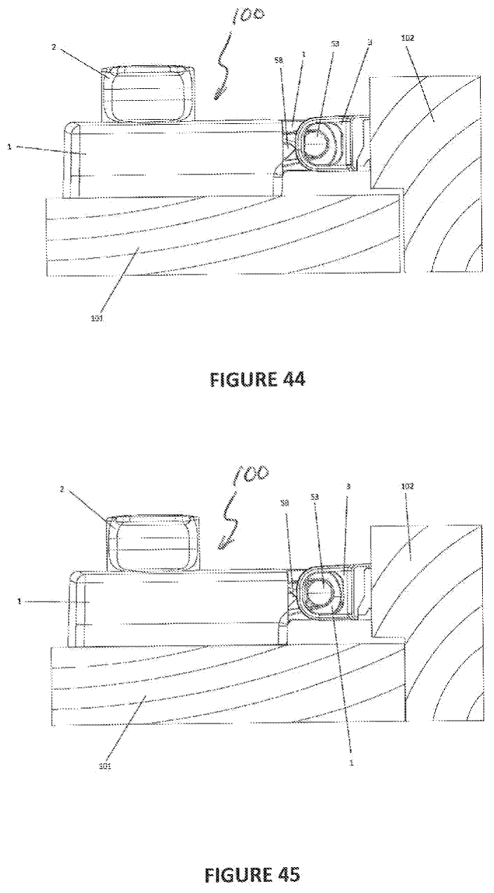

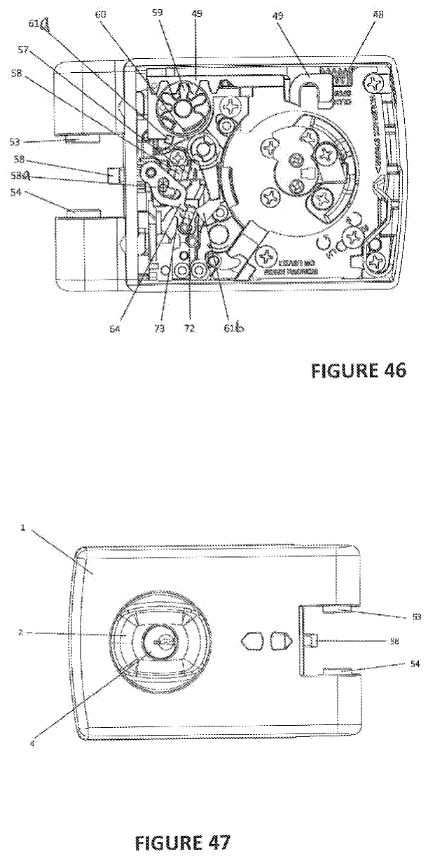

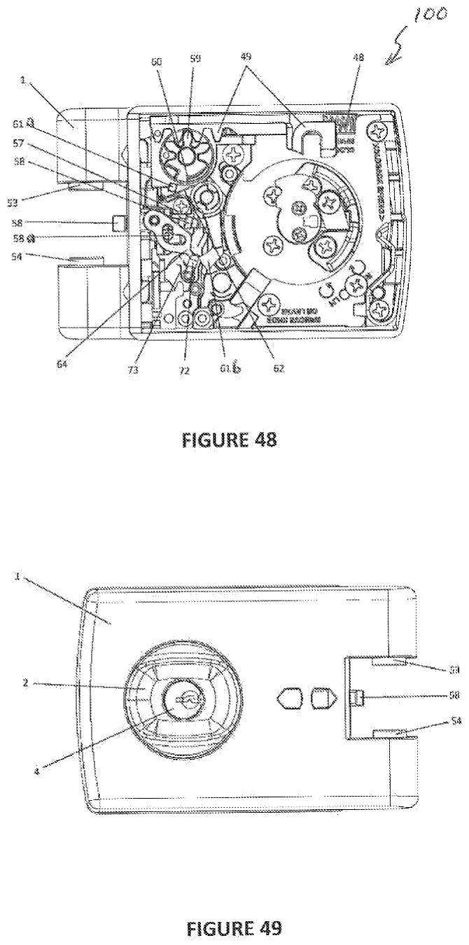

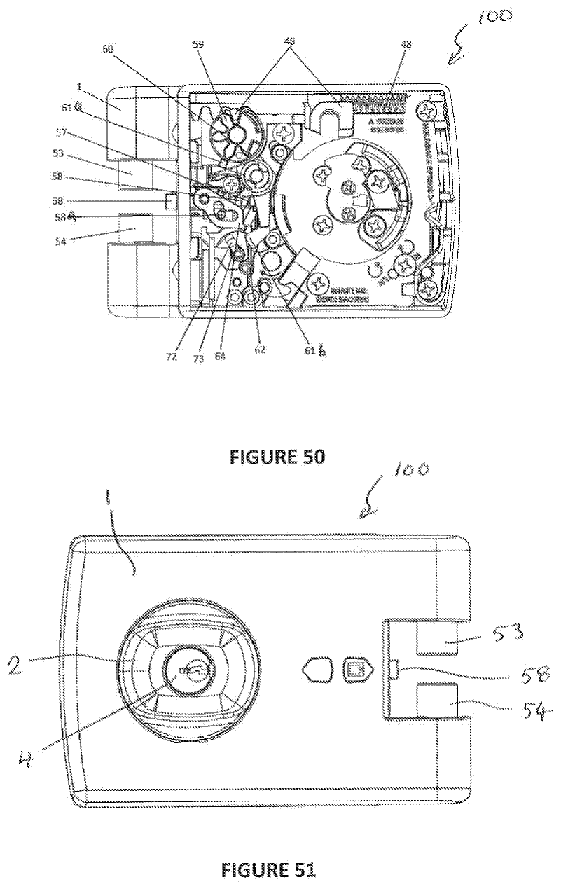

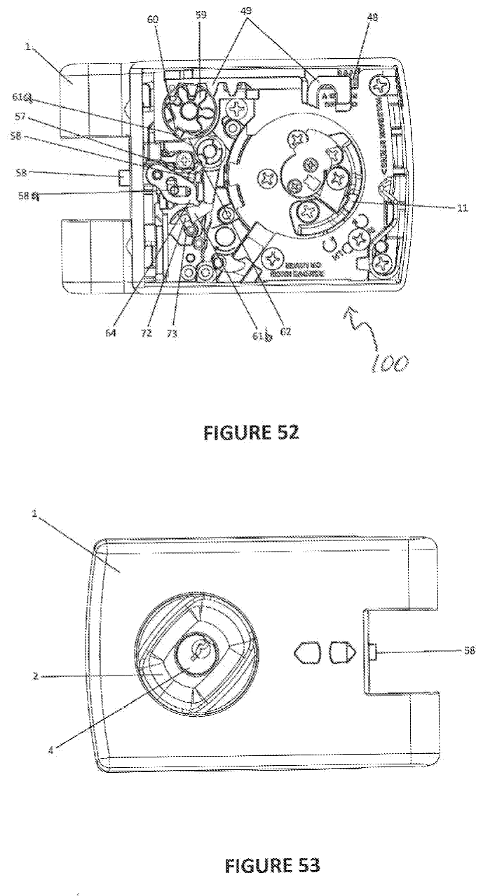

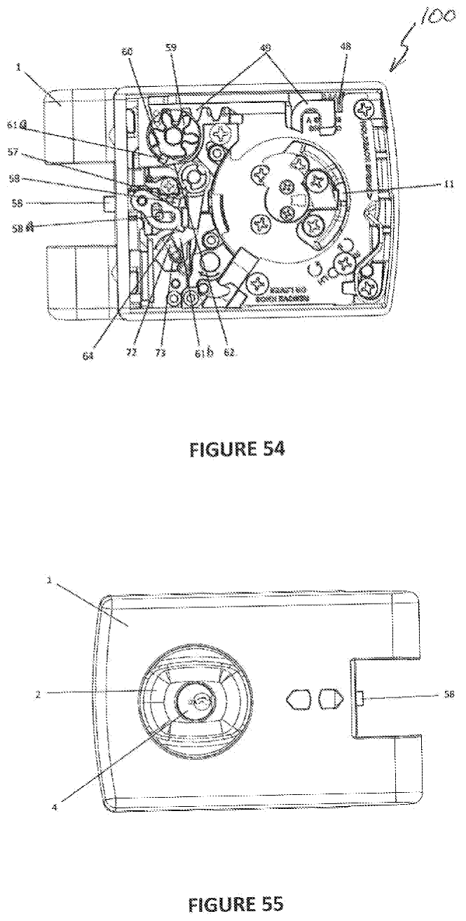

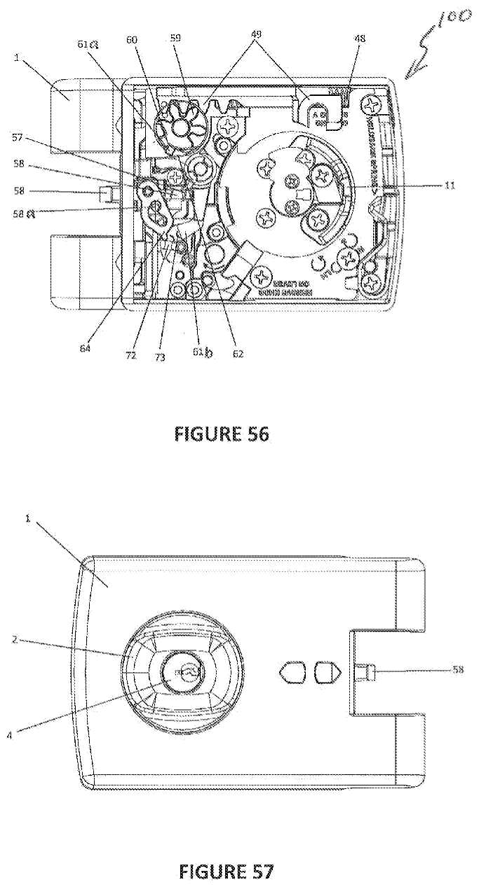

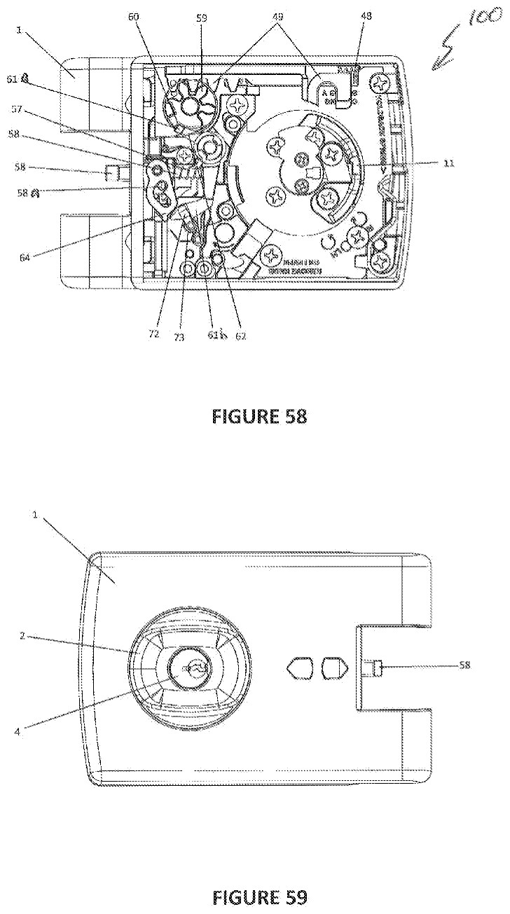

Referring to FIGS. 28 to 45, this improvement provides a convenient, user friendly as well as high security latching lock that can be fitted to doors of multiple operating directions. Being a multi-functional latching lock, This improvement also offers the benefits of easy to manufacture, stock and sell. The economies of scale brought in all three areas can thus be achieved by the synergistic design of the present improvement.

The location of the door closing sensor 58 on the lock and the way the sensor 58 functions specifically allow it to sense an approaching strike and produce secure latching of the lock 100 from all three usual door closing directions.

The case 1 of the lock 100 comprising a main box like portion and the case 1 further includes two latch member opposing sections extending from one side of the case 1 to create two ends of a substantially C-shape forming the lock space therebetween and wherein the door closing sensor button 58 is so positioned and shaped to protrude and can interact with an associated strike 3 wherein the strike 3 approaches from one of the following directions:
a first side of the C-shape formed by the two latch member opposing sections
a second side of the C-shape formed by the two latch member opposing sections
an inline end position into the C-shape formed by the two latch member opposing sections.
   It should be noted that the lock 100 can equally work when that strike 3 approaches from any of the following three door operating directions:
hingedly opening inwards,
hingedly open outwards, and
sliding in parallel plane

In the present embodiment, the door closing sensor 58 is in the form of a button including first and second suitably shaped surfaces. The first suitably shaped surface is configured for effecting latching movement into the main box like portion of the lock 100 when engaged by the strike 3 from a first side of the C-shape formed by the two latch member opposing sections. The second suitably shaped surface is opposed to the first suitably shaped surface for effecting latching movement into the main box like portion of the lock 100 when engaged by the strike 3 from a first side of the C-shape formed by the two latch member opposing sections. An end surface effects a latching movement into the main box like portion of the lock 100 when engaged by the strike 3 from an inline end position into the C-shape formed by the two latch member opposing sections.

Variations may include outwardly extending bolts instead of inwardly if the case is shaped differently.

The present improvement can also be used to provide a latching deadbolting lock for all 3 door operating directions, without being jimmy proof, or even possibly for a latching multi-point locking system.

Improvement 3—Latching with Sensor Moving and Moving in One Direction Only

Referring to FIGS. 12 to 25 and FIGS. 46 to 59, for a latching deadbolt, one aspect of having a latching function may make the lock 100 harder to use. For example, if a user is opening a door with a key with both arms full of groceries, once the bolts are retracted so the door is free, it is preferable that the bolts 53 & 54 stay retracted when the user lets go of the key to go inside instead of the user having to keep the key turned to hold the bolts retracted. If the present lock had a simple trigger that let the bolts 53 & 54 close when the door was shut, the bolts 53 & 54 would always be ready to extend when the lock 100 was opposite the strike 3 and so the bolts 53 & 54 would always re-engage the strike 3 when the user let the key go. This could make entering the door less than straightforward and easy. A slightly less inconvenient but similar problem is that even when opening the door from inside with a knob or lever, the knob or lever would still need to be kept turned during the door opening to prevent the bolts 53 & 54 from re-extending and securing the door.

Therefore the improvement is provided by the lock 100 having: i) the latching member 61 retaining the rotating member 59/60 in a latched position when the rotating member 59/60 is rotated to withdraw the bolts 53 & 54 from the lock space to a door unsecured position, and ii) the rotating member 59/60 interacting with the latching member 61 when the door closing sensor button 58 senses the associated approaching strike 3 resulting in unlatching of the bolt thereby allowing its return to the door secured position when the door closing sensor button 58 senses the motion of the door being closed.

The door closing sensor button 58 is depressible by its associated approaching strike 3 and can interact with the latching member 61 to unlatch the bolts 53 & 54 allowing its return to the door secured position. The interaction of the door closing sensor button 58 is such that the door closing sensor button 58 only interacts with the latching member 61 when the door closing sensor button 58 is in motion being depressed.

The above described benefit makes the use of the lock 100 straightforward without the need for the user to retain the bolts 53 & 54 retracted by keeping the key or knob 2 turned during the opening operation. In contrast, in previous designs, if the key wasn't kept turned, the bolts 53 & 54 would re-extend when the door opened and so not be ready to latch when the door closed, unless the key or knob 2 was again turned. Therefore this is an advantage over the last known art for a latching deadbolt and avoids the pain and awkwardness of operation at least when the user has a bag full of groceries in hand.

The above described mechanism ensures that the bolts 53 & 54 are only triggered to extend when the door (not shown) is closing for a first time and the door closing sensor button 58 is moving being pushed inwards into the lock by contact with the strike 3. When the door is shut and the door closing sensor 58 is static but located inside the lock 100, and when the door is being opened and the door closing sensor 58 is sprung extending out of the lock 100, the bolts 53 & 54 are not triggered to extend.

This ensures that once the bolts 53 & 54 are retracted by key (and also by use of the internal knob or lever in just the same way), they remain retracted until the door closing sensor button 58 is moving being depressed again for the first time, after the door has been opened and then is being re-closed.

The exact arrangement and structure of the door closing sensing mechanism could be changed and repositioned.

Such a feature could apply in other locks. For instance, there can be electrical or electronic switching or sensing and signalling of some function.

Also it could equally be used to activate some function during door opening only instead of door closing only.

### In Operation

Step 1—At rest—the bolts are extended and deadbolted, as illustrated in FIGS. 12 & 13.

Step 2—Lock; partly open

Referring to FIGS. 14 and 15, the bolts 53 & 54 are half retracted. The knob 2 is half turned anticlockwise (looking from the outside as shown in FIG. 15) and the knob driving boss connected through bolt drive rack connection (with interconnecting mechanism not shown here—in this regard, refer to the relevant description below for FIG. 75) withdraws the drive rack 49 to the right (compressing and charging the closing spring member 48) rotating the bolt drive gear 59 clockwise as illustrated in FIG. 14 (which has two locating pins one connecting with each bolt). This results in retracting both bolts 53 & 54 into the lock case 1. As the knob 2 has rotated, this motion has charged a knob centralising spring 9 (not shown).

Step 3—Lock Fully Open

As shown in FIGS. 16 and 17, the bolts 53 & 54 are fully retracted and latched open with the door being ajar. The knob 2 is turned fully anticlockwise (looking from the outside as shown in FIG. 17) and the knob driving boss 11 connected through the bolt drive rack connection (with interconnecting mechanism including lost motion not shown here—in this regard, refer to the relevant description below for FIG. 75) withdraws the drive rack fully to the right (compressing the closing spring member 48 fully) rotating the bolt drive gear 59 fully clockwise as illustrated in FIG. 16 (which has two locating pins one connecting with each bolt). This results in retracting both bolts 53 & 54 fully into the lock case 1. The latching member 61 has rotated clockwise as illustrated in FIG. 16 under the influence of the latch spring 62 and the latch heel 61a has moved into a recess in the bolt drive gear 59 now locking this gear 59 from rotating back anticlockwise as illustrated in FIG. 16 (as would be driven by the charged closing spring 48). This results in retaining of the bolts retracted. As the knob 2 further rotates, this motion further charges the knob centralising spring 9 not shown.

Step 4—Lock Fully Open

Referring to FIGS. 18 and 19, the bolts 53 & 54 are fully retracted, latched open and knob 2 back to central with the door ajar. The knob 2 is released and re-turned central clockwise (looking from the outside as shown in FIG. 19) urged by the charged knob centralising spring 9 (not shown). The knob 2 comes to rest neutrally sprung against the knob direction setting screw 16 which prevents further movement past the central position. With the knob's interconnecting mechanism including lost motion between the knob driving boss 11 and the bolt drive rack connection, no other effect is had in the lock 100. The bolts 53 & 54 are now withdrawn but charged ready to be sprung extended.

Step 5—Lock Fully Open

Referring to FIGS. 20 and 21, the door (not shown) is starting to close prompting door closing sensor initial movement. The door (not shown) on which the lock 100 is mounted is being closed and the tip of the door closing sensor 58 contacts the lock strike (not shown) as the door is being closed. The door closing sensor 58 starts to be depressed towards the right into the lock case 1 against the door closing sensor spring 57. The door closing sensor drive pin 58a starts to act on the first latch drive lever 64 which rotates anticlockwise as shown in FIG. 20. This in turn contacts the second latch drive lever 72 which rotates clockwise as illustrated in FIG. 20 until it contacts the latch drive (ie. latch hook) 61b of the latching member 61.

Step 6—As door closes

With reference to FIGS. 22 and 23, as the door closes, the door closing sensor 58 unlatches the bolts 53 & 54. The door is closed further and the door closing sensor 58 continues moving right further into the lock case 1 compressing the door closing sensor spring 57 further. The door closing sensor drive pin 58 rotates the first latch drive lever 64. Subsequently the second latch drive lever 72 rotates clockwise as illustrated in FIG. 22 charging up the second latch drive lever spring 73. The second latch drive lever 72 also acts on the latch drive (ie. latch hook) 61b so rotating the latching member 61 itself anticlockwise as illustrated in FIG. 22 against the urging of the latch spring 73. This last movement withdraws the latch heel 61a from engagement with the recess on the bolt drive gear 59 leaving it free to rotate anticlockwise under the urging of the closing spring 57 acting through the drive rack 49, as illustrated in FIG. 22.

Step 7—As door closes

Referring to FIGS. 46 and 47, the bolts 53 & 54 partly extend and the door closing sensor 58 continues its movement. The bolt drive gear 59 rotates anticlockwise as illustrated in FIG. 46 under the urging of the closing spring 48 driving through the drive rack 49. The two bolts 53 & 54 extend partly but cannot engage into the strike 3 as the bolt ends are not yet opposite the strike bolt aperture. As the door (not shown) closes further, the door closing sensor 58 moves further and urges the door closing sensor drive pin 58 to rotate the first latch drive lever 64 further and subsequently the second latch drive lever 72 rotates further clockwise as illustrated in FIG. 46 further charging the second latch drive lever spring 73 and also acting further on the latch drive (ie. latch hook) 61b to rotate the latching member 61 itself further anticlockwise against the urging of the latch spring 73 as illustrated in FIG. 46. At this point, the tip of the first latch drive lever 64 is just about to skip past its influenced corner of the second latch drive lever 72.

Step 8—Door closing sensor continues movement

As shown in FIGS. 48 and 49, the door closing sensor's 58 further movement urges the door closing sensor drive pin 58a to rotate the first latch drive lever 64 further and its tip slips past the influenced corner of the second latch drive lever 72. By this time, the second latch drive lever 72 and then subsequently the latch drive (ie. latch hook) 61b and ultimately the latching member 61 are no longer influenced to move further.

Step 9—The door closing sensor 58 can continue inwards movement but the latching member 61 is set ready to latch the retracted bolts 53 & 54 while the bolts 53 & 54 extend fully to engage the strike and are deadbolted.

Referring to FIGS. 50 and 51, the door (not shown) continues closing and this positions the bolts 53 & 54 opposite the strike bolt aperture whereupon the bolts 53 & 54 have extended fully as urged by the closing spring 48. The door closing sensor 58 is held inwards by the strike 3 but now that the tip of the first latch drive lever 64 has slipped past the corner of the second latch drive lever 72, the second latch drive lever 72 is no longer held clockwise but rotates anticlockwise back to a neutral position as urged by the charged second latch drive lever spring 72. Therefore, at this time, the second latch drive lever 72 is not influencing the latch drive (ie. latch hook) 61b and so the latching member 61 under the influence of the latch spring 62 is ready to urge the latch heel 61a to re-engage with the bolt drive gear 59 should the bolt drive gear 59 be rotated clockwise again when the bolts 53 & 54 are retracted, even though the door closing sensor 58 is still depressed.

Referring to FIGS. 52 and 53, the door is sitting closed. The bolts 53 & 54 are retracted and latched open, leaving the door (not shown) possible to open. The door is still closed however and the door closing sensor 58 is still depressed by the strike 3.

As shown in FIGS. 52 and 53, the knob 2 is turned fully anticlockwise (looking from the outside as shown in FIG. 53) and the knob driving boss 11 connected through the bolt drive rack connection (with interconnecting mechanism including lost motion not shown here—in this regard, refer to the relevant description below for FIG. 75) withdraws the drive rack 49 fully to the right (compressing the closing spring member 48 fully) thereby rotating the bolt drive gear 59 fully clockwise as illustrated in FIG. 53 (which has two locating pins one connecting with each bolt). This results in retracting both bolts 53 & 54 fully into the lock case 1. The latching member 61 has rotated clockwise as illustrated in FIG. 52 under the influence of the latch spring 62 and the latch heel 61a has moved into a recess in the bolt drive gear 59 thereby now locking this gear 59 from rotating back anticlockwise as illustrated in FIG. 52 (as would be driven by the charged closing spring 57). This results in retaining the bolts 53 & 54 retracted. As the knob 2 was rotated anticlockwise, this motion charged a knob centralising spring 9 (not shown).

Referring to FIGS. 54 and 55, the door (not shown) is sitting closed. The bolts 53 & 54 are retracted leaving the door possible to open and the knob 2 is returned to central.

The knob 2 is released and re-turns clockwise to central (looking from the outside as shown in FIG. 55) urged by the charged knob centralising spring 9 (not shown). The knob 2 comes to rest neutrally being sprung against the knob direction setting screw 16 which prevents further movement past the central position and with the knobs 53 & 54 interconnecting mechanism including lost motion between the knob driving boss 11 and the bolt drive rack connection, no other effect is had in the lock. The bolts 53 & 54 are now withdrawn but charged ready to be sprung extended. The door (not shown) is still closed and the door closing sensor 58 depressed.

As shown in FIGS. 56 and 57, the door (not shown) starts to open and the door closing sensor 58 extends part way.

The door 2 is opened and shows component positions part way through the process of the door closing sensor 58 moving outwards under the urging of the door closing sensor spring 57 as the lock 100 moves away from the strike 3. The door closing sensor drive pin 58a starts to act upon the first latch drive lever 64 which rotates clockwise as illustrated in FIG. 56. This in turn contacts the second latch drive lever 72 which then rotates anticlockwise charging the second latch drive lever spring 73, as shown in FIG. 56. These motions continue as the door closing sensor 58 continues to move outwards until all reach positions as shown here. At this point, the tip of the first latch drive lever 64 is just about to skip past an opposite influenced corner of the second latch drive lever 72.

As shown in FIGS. 58 and 59, the door (not shown) is open so the door closing sensor 58 fully extends.

The door closing sensor 58 is fully extended and the tip of the first latch drive lever 64 has slipped past the opposite influenced corner of the second latch drive lever 72. As the second latch drive lever 72 is no longer held anticlockwise, it rotates clockwise back to a neutral position as urged by the charged second latch drive lever spring 73. Therefore, at this time, the 2nd latch drive lever 72 is not influencing the latch drive (ie. latch hook) 61b and so the latching member 61 under the influence of the latch spring 62 remains in a position allowing the latch heel 61a to remain engaged with the bolt drive gear 59 keeping the bolts 53 & 54 retracted. The door closing sensor 58 is again extended ready to sense the presence of a strike 3 and release the bolts 53 & 54 when the door (not shown) is next closed.
Improvement 4—Deadbolt being Selectively Latching or Driven

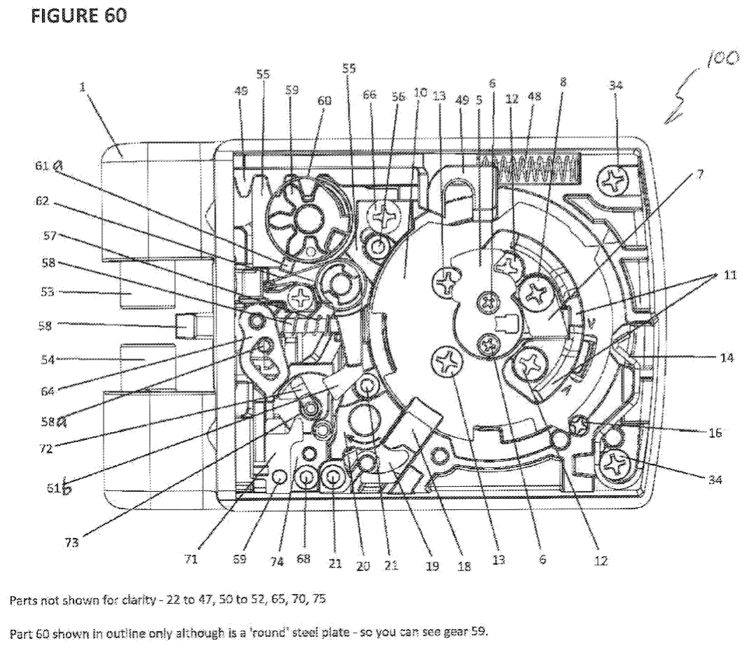

Referring to FIGS. 60 and 61 to 70, there is an improved lock which is provided by a deadbolting jimmy proof lock that can be used as both latching and manually driven in one product.

This is a further improvement that can be used separately but is preferably synergistically used in combination with other improvements providing a deadbolting jimmy proof lock that can be used as both latching and manually driven in the one product.

In the deadbolting lock where the deadbolt is sprung into its strike, the spring might not have sufficiently thrown the bolt(s) into the strike. Deadbolting only happens when the spring has sufficiently thrown the bolt(s) into the strike.

When installed in applications where alignment of the strike and deadbolt varies to the extent that it is outside of the required geometry that the deadbolts are able to enter the strike, it is preferred that the deadbolts are directly driven to ensure correct engagement every time the lock is locked.

The product of the present invention can be set to work both ‘automatically’ with the bolts being sprung into the strike but also alternately and optionally with the bolts being manually driven by hand.

To achieve the above, the lock 100 has at least two field settable states including:
i) a first settable state where the movement and position of the bolt(s) is/are purely adjusted by operation of the actuating member; and
ii) a second settable state where the movement of the bolt(s) to its/their withdrawn position is achieved through operation of the actuating member but movement of the bolt(s) into a door secured position is achieved without the need for input from the actuating member.

The lock 100 has slidably mounted bolt(s) in the case 1, with the bolt(s) 53 & 54 being positionable relative to an associated strike 3 to secure a door (not shown). The bolts 53 & 54 are also positionable to be withdrawn from the associated strike 3 to leave the door unsecured. The actuating member facilitates movement of the bolts 53 & 54 so that the connection between the actuating member and the bolts 53 & 54 is settable between the two states. The difference between the two states is that in the first settable state, a spring member 48 is removed, and the actuating member's motion range is increased so that it can take over the job of the removed closing spring member 48 in driving the bolts 53 & 54 extended. Latching of the rotating member 59/60 (the one directly moving the bolts 53 & 54) is also removed again leaving the actuating member clear to drive the bolts 53 & 54 extended.

In the first state, the actuating member includes the rotating member 59/60 engaging at least one or both bolts 53 & 54 with the rotation of the rotating member 59/60 causing relative linear motion of the bolts 53 & 54 to substantially withdraw the bolts 53 & 54 from the lock space and the direct drive from the actuating member effects the closing spring member 48 to substantially extend the bolts 53 & 54 into the lock space to effect locking.

In the second state, the actuating member only engages with the rotating member 59/60 while it in turn engages at least one or both bolts 53 & 54 with the rotation of the rotating member 59/60 causing relative linear motion of the bolts 53 & 54 to substantially withdraw the bolts 53 & 54 from the lock space. This means the actuating member is not engaged and only the closing spring member 48 is used to substantially extend the bolts 53 & 54 into the lock space to effect locking.

Therefore the lock 100 is an easily re-configured latching or manual lock combined in the one product. The latching function involves the lock 100 using spring pressure to enter the bolts 53 & 54 into the strike 3. So there are a combination of parts that sense a door closing and then spring the bolts 53 & 54 into the strike 3. To set the lock to work manually, extra movement of the key or knob drive 11 (for example) is enabled to allow the knob 2 to both retract the bolts 53 & 54 (as before) but also extend the bolts 53 & 54 manually without use of a spring. The latching member 61 can be re-set to latching again by reversing these changes.

Here is a description of changing the lock function

Step 1—At rest

The bolts 53 & 54 are extended and deadbolted and set to latching function as shown in FIG. 60

Step 2—At rest

The bolts 53 & 54 are extended and deadbolted. The process is to re-set to driven function. To remove the ‘automatic’ latching function and change to both manual retraction and extension of the bolts 53 & 54, there are four actions to complete as shown in FIGS. 61 & 62.
1. Remove the closing spring member 48 (as a result, the bolts 53 & 54 won't be spring driven extended).
2. Remove the holdback spring 14 (as a result, the knob cannot be detented open holding the bolts retracted).
3. Remove the knob direction setting screw 16 as shown in FIG. 5 (as a result, the knob will be able to rotate in both directions from central/neutral).
4. Defeat the door closing sensor 58 and latch operations
This process involves the following:
i) manually push the door closing sensor 58 fully into the lock case and hold; and
ii) with a small screwdriver in the driving slot, move latch disable switch 71 across a detent upwards as illustrated in FIG. 61 from the outer position into this new position towards the middle of the lock. This in turn locks the door closing sensor 58 in place recessed into the lock. It also acts on the second latch drive lever 72 to rotate it clockwise which in turn acts on the latch drive (ie. latch hook) 61b to rotate the latching member 61 anticlockwise removing the latch heel 61a from possible engagement with the bolt drive gear 59. This leaves the bolt drive gear 59, the bolts 53 & 54 and the drive rack 49 free to move when influenced to do so by the knob 2 or key.
Turning to FIGS. 61 to 68, the driven operation of the lock 100 as distinct from the latching operation will now be described.

Step 1—bolts fully retracted as illustrated in FIGS. 63 & 64

The knob 2 is turned anticlockwise as illustrated in FIG. 64. To retract the bolts 53 & 54 into the lock case 1 to unsecure a door (not shown), the knob 2 is rotated anticlockwise (looking from the outside as shown in FIG. 64) and the knob driving boss 11 connected through bolt drive rack connection (with interconnecting mechanism not shown here—in this regard, refer to the relevant description below for FIG. 75) withdraws the drive rack 49 to the right rotating the bolt drive gear 59 clockwise as illustrated in FIG. 63 (which has two locating pins one connecting with each bolt 53, 54). This results in retracting both bolts 53 & 54 into the lock case 1. As the knob 2 has rotated, this motion has charged a knob centralising spring (not shown).

Step 2—Fully open as illustrated in FIGS. 65 & 66

The bolts 53 & 54 are fully retracted with the knob 2 back to central. The knob 2 is released and re-turned clockwise to central (looking from the outside as illustrated in FIG. 66) through the urging of the charged knob centralising spring 9 (not shown). The knob 2 comes to rest neutrally sprung.

Step 3—Bolts extended and deadbolted as illustrated in FIGS. 67 & 68

The knob 2 is rotated clockwise as illustrated in FIG. 6. To extend the bolts outside the lock case 1 to secure a door, the knob 2 is rotated clockwise (looking from outside as illustrated in FIG. 68) and the knob driving boss 11 connected through bolt drive rack connection (with interconnecting mechanism not shown here—in this regard, refer to the relevant description below for FIG. 75) advances the drive rack 49 to the left rotating the bolt drive gear 59 anticlockwise (which has two locating pins one connecting with each bolt 53,54) and so extending both bolts outside the lock case 1. As the knob 2 has rotated, the knob centralising spring 9 (not shown) is charged by this motion as a result.

Step 4—Bolts extended and deadbolted as illustrated in FIGS. 69 & 70

The knob 2 is rotated back to central. The knob 2 is released and re-turned anticlockwise to central (looking from the outside as illustrated in FIG. 70) through the urging of the charged knob centralising spring 9 (not shown). The knob 2 comes to rest neutrally sprung.

Step 7—Reverting to the latching function

To reinstate the ‘automatic’ settable latching function reverse the changing the lock function steps outlined.

### Improvement 5—Selectable Exterior Drive Angles and Forces

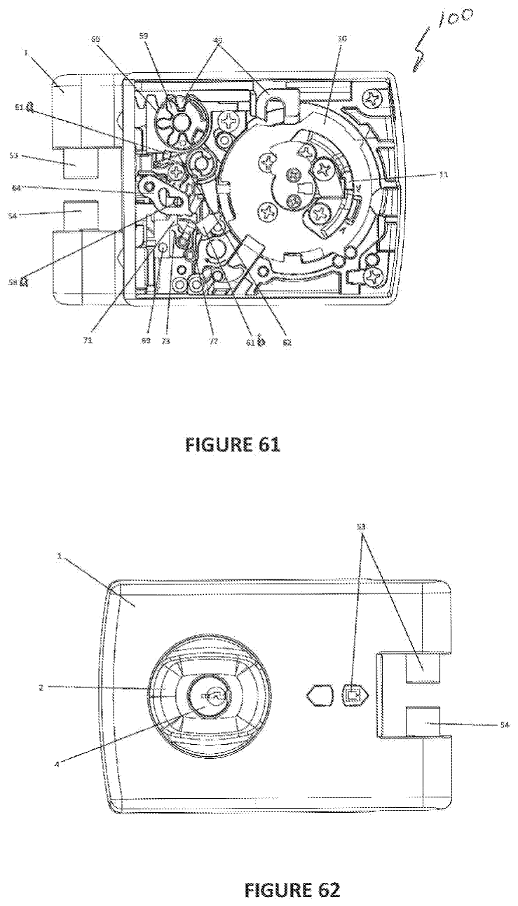

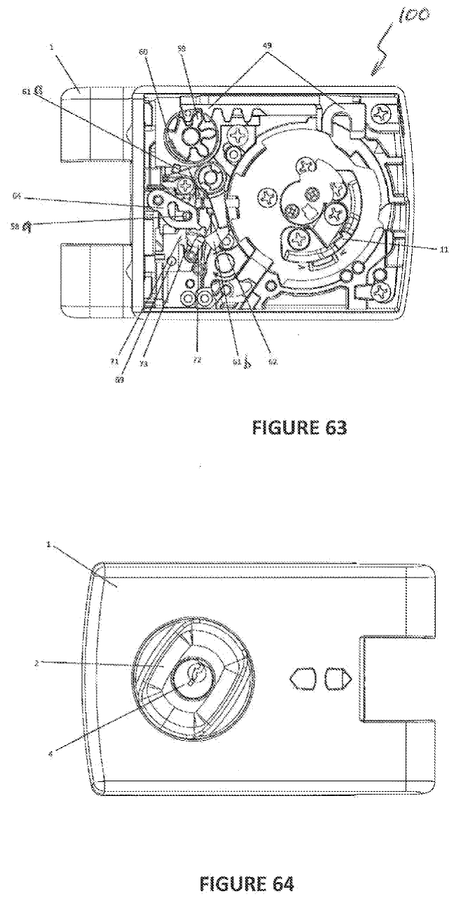

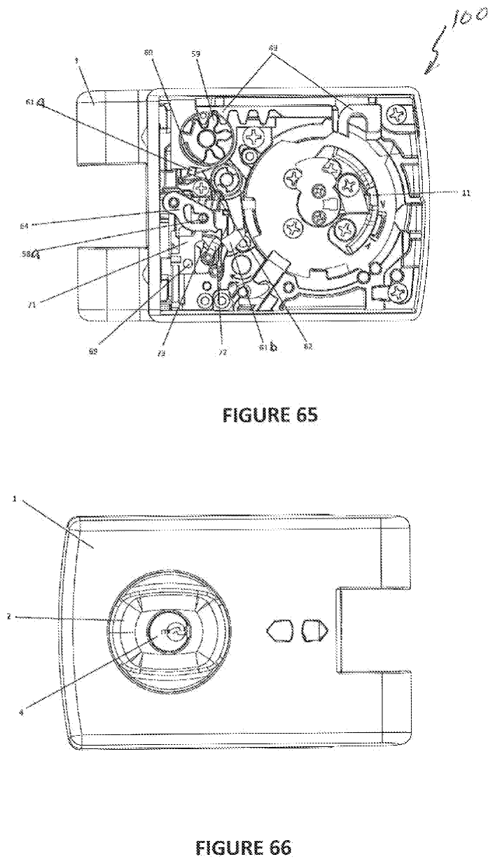

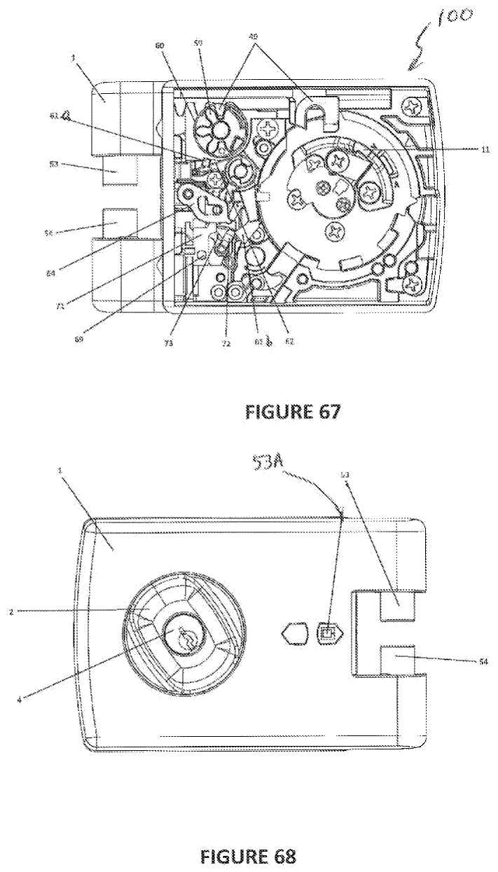

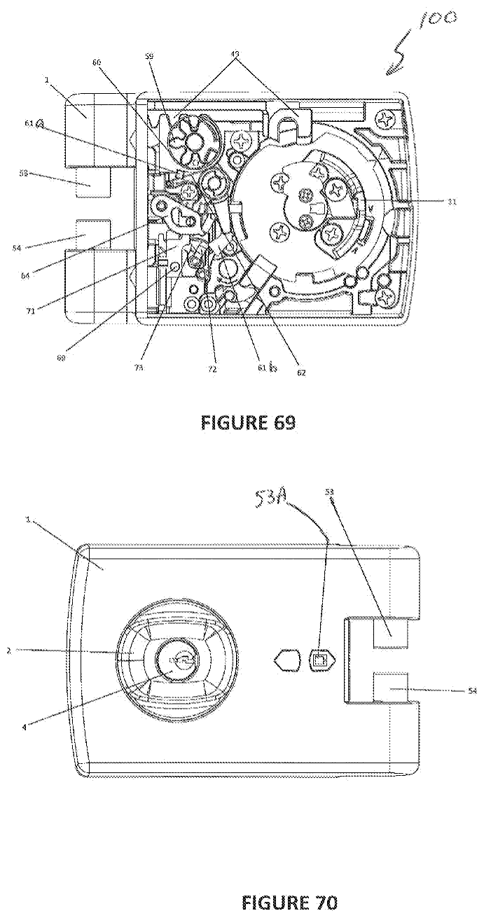

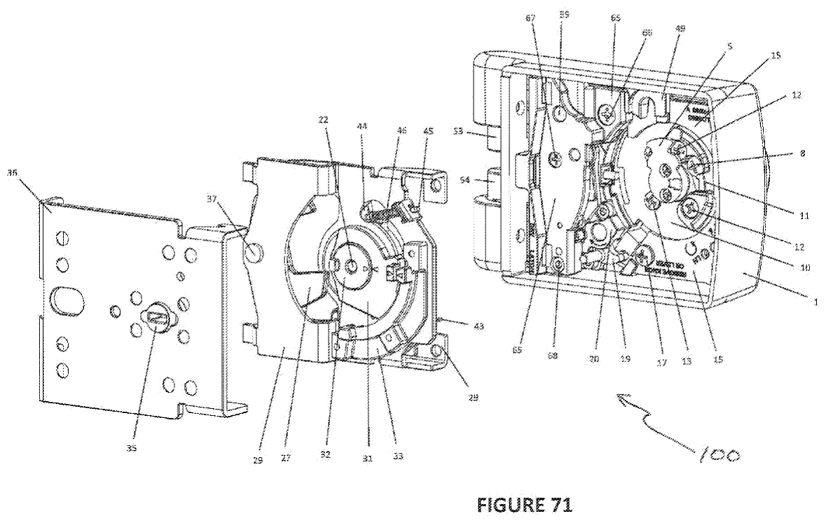

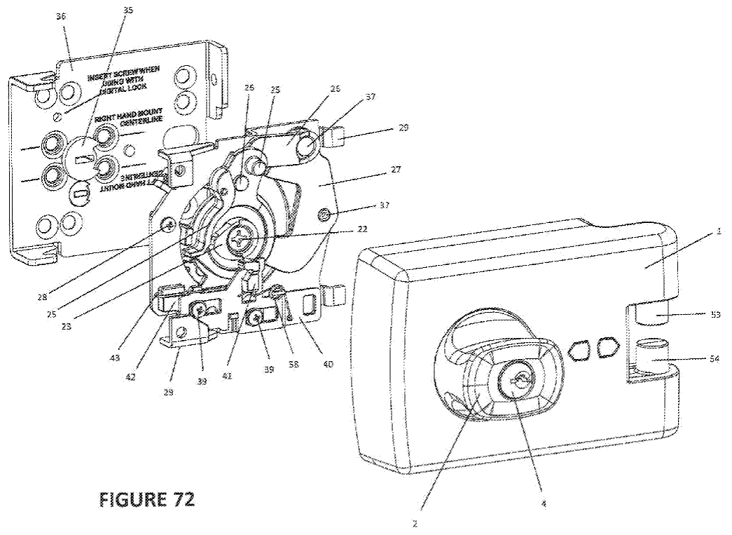

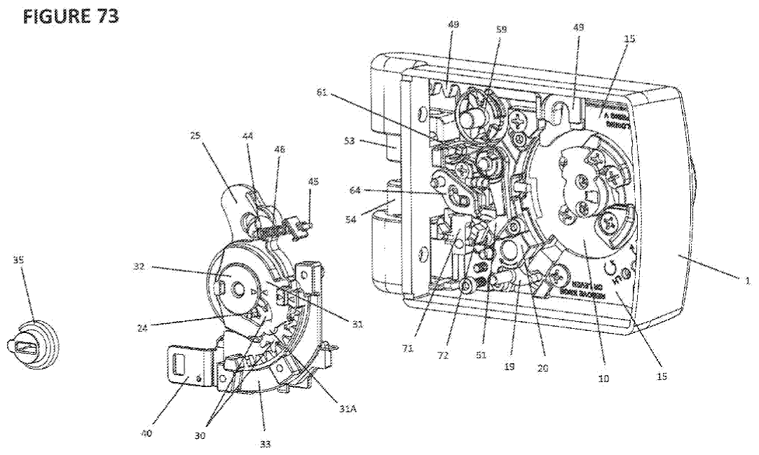

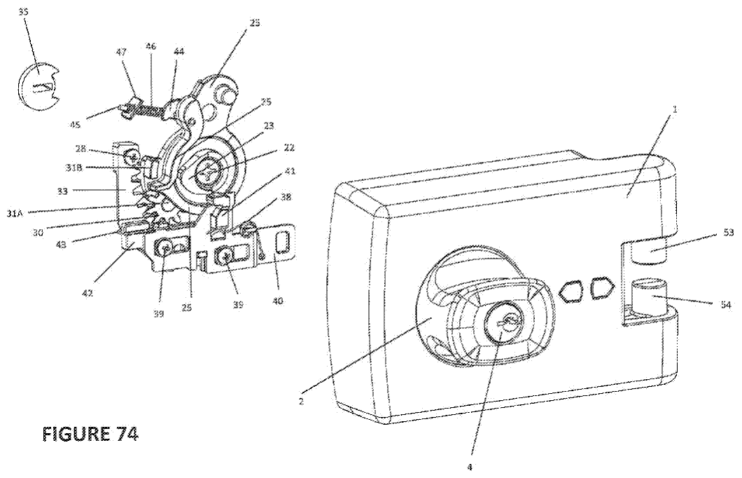

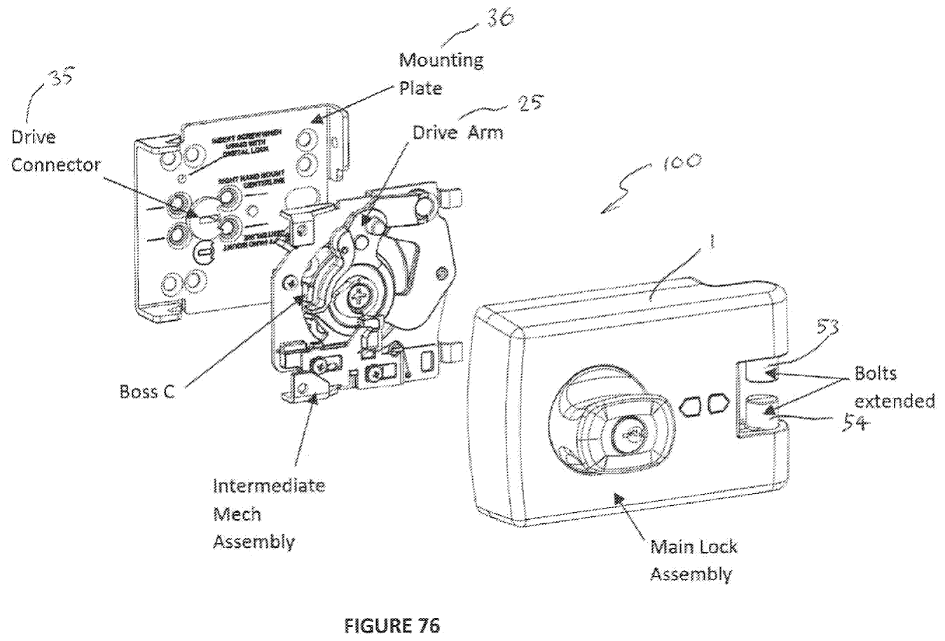

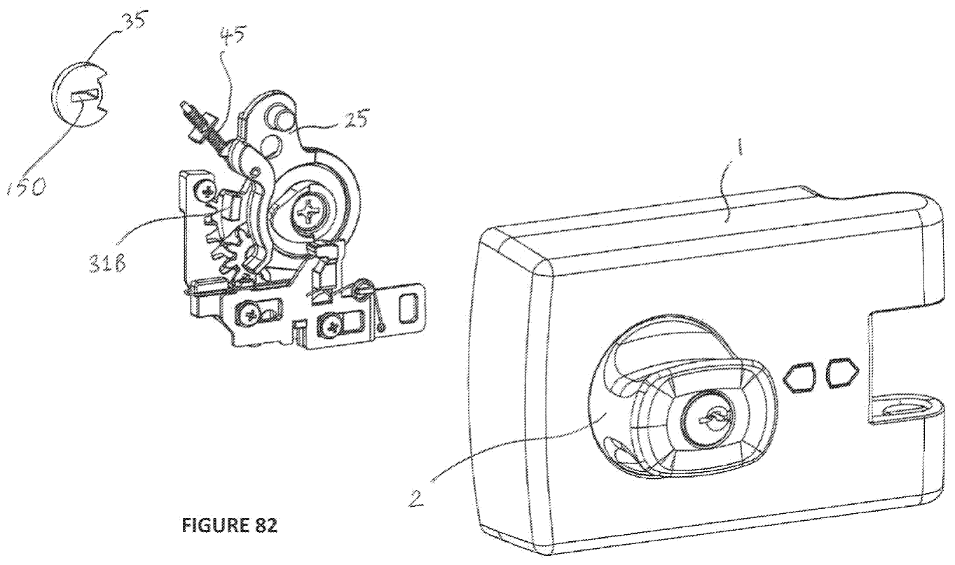

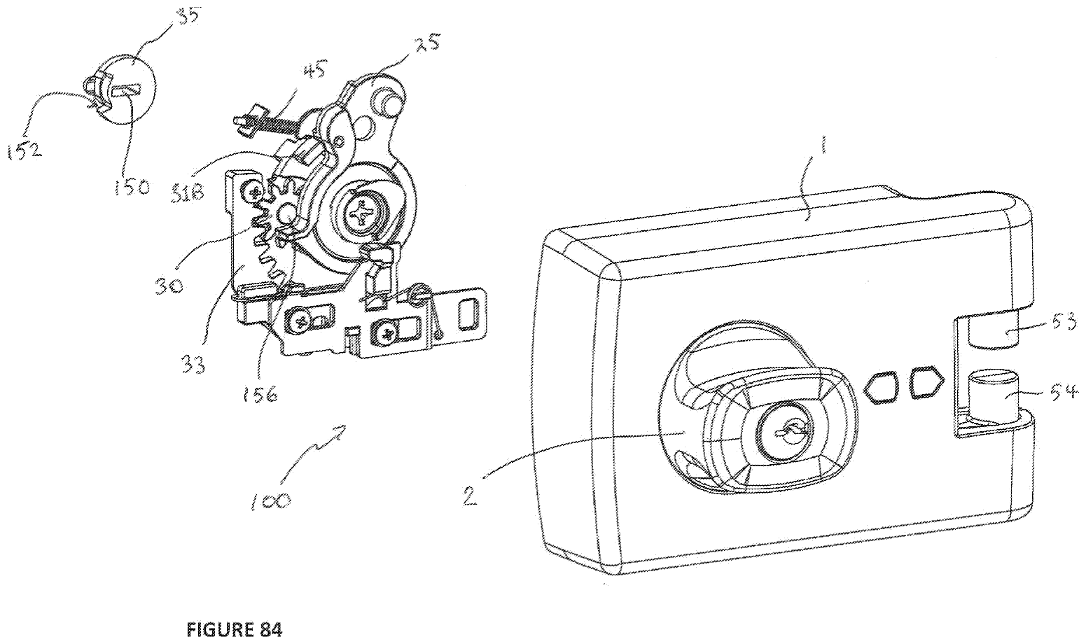

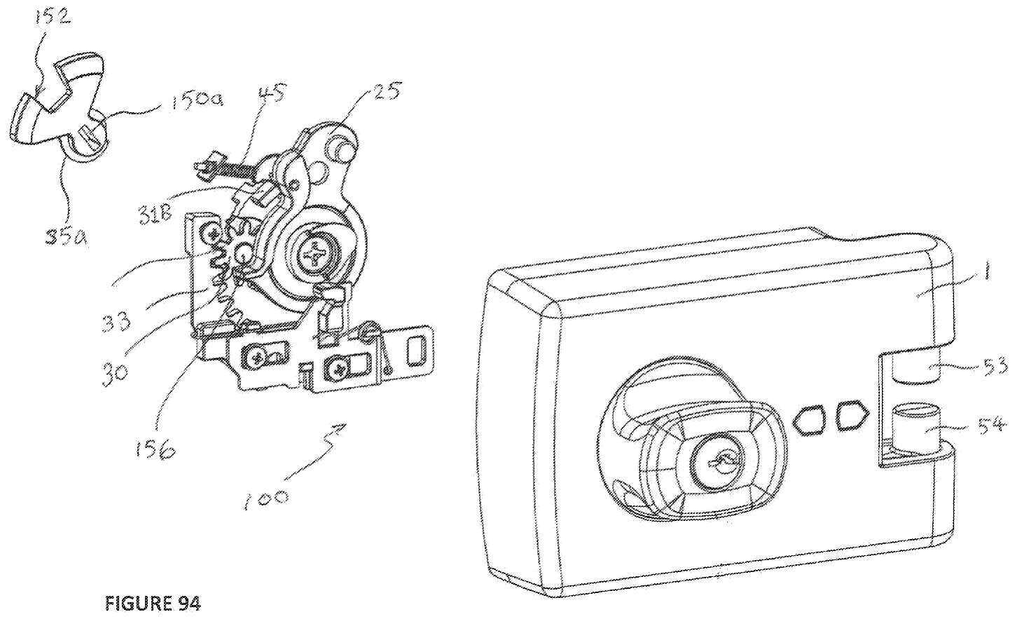

Referring to FIGS. 71 to 96, there is an improved lock 100 which is both key operable at a low operating force capable of resulting in a high rotation angle and handle operable at a low rotation angle.

Digital access door knob or handle interfaces are becoming much more common and fitment is required on the outside of doors mating to locks such as that described here. However, to work with a door knob or handle, these lock assemblies must provide full lock operation from a knob or handle turn of no more than 90 degrees for the knob or handle to be useable.

The outside connection with a lock accessible on the outer side of a door is most usually made to a key drive of some sort. A key head is quite small compared with say a door knob or a door handle. If in use, the key rotation is also limited to a maximum of 90 degrees and say if the torsional forces needed to be applied to the comparatively small size key head on the outside of a door are the same as those applied to the inside door knob or handle to retract a bolt and allow entry, the forces on a user's fingers from using the key might be uncomfortably high.

The forces are reduced on the key drive by gearing the key drive so that the operating torque is reduced. This gearing means however that the key must rotate further to operate the lock mechanism to the same degree. This is not important when considering use of a key as the key head is small and can even be rotated a full 360 degrees if required compared with a knob or handle which can only usefully rotate from say 45 to 90 degrees before the rotation becomes uncomfortable for the user or impossible due to surrounding door framing construction.

Therefore a preferred form is that the lock 100 includes an actuator for actuating a bolt driving mechanism with a gear drive mechanism that connects with the rotating member 59/60 engaging at least one or both bolts 53 & 54 allowing for a geared ratio between the actuator and the rotating member 59/60.

Also, the lock 100 is adaptable with the same structure able to be actuated by one of a key or one of a door knob or handle or a digital lock. The structure has one of a key—or one of a door knob or handle or a digital lock engaging with the rotating member 59/60 which engages at least one or both bolts 53 & 54 with the rotation of the rotating member 59/60 causing relative linear motion of the bolts 53 & 54 to substantially withdraw the bolts 53 & 54 from the lock space.

The bolt driving mechanism engages with a turntail drive bar for driving the bolts 53 & 54 to substantially extend or withdraw from the lock space.

The gear drive mechanism includes an epicyclic gear train giving a high gear ratio and so requiring a large rotation of the actuator while similarly reducing the key force required to operate the lock.

The lock includes a bolt driving mechanism selectively engageable with the selected one of the key or one of the door knob or handle or a digital lock.

In one form, the lock 100 includes a bolt driving mechanism with a gear drive mechanism including a gear train and at least two selectable actuator connection points. One actuator connection point allows an actuator to drive the bolt driving mechanism directly for a particular function bypassing the gear train. Another actuator connection point allows the actuator to drive the bolt driving mechanism through the gear train thereby changing the number of turns required of the actuator to operate the bolt drive mechanism to achieve the same particular function. The bolt drive mechanism includes the rotating member 59/60 engaging at least one or both bolts 53 & 54 with the rotation of the rotating member 59/60 causing relative linear motion of the bolts 53 & 54 to substantially withdraw the bolts 53 & 54 from the lock space.

The benefit of the new improvement is that the lock has an easily re-configured interface which is capable of accepting either a key or digital lock connection and which can be changed at some later time. It is important to note that the present improved lock 100 is both key operable at a high rotation angle and handle operable at a low rotation angle. In one embodiment, one component may be swapped for another inside the lock 100 at installation to cover both key and digital lock operation.

The improved lock 100 includes an epicyclic gear train on its key drive input side. When a key is required, a particular drive connector 35 component is inserted in the lock at installation and then coupled to the key cylinder and turntail drive bar. This drive connector 35 connects to the epicyclic gear train at a point where a high gear ratio is given, requiring a large key rotation but similarly reducing the key force required to operate the lock 100. If a digital lock interface is required, a particular alternative digital drive connector component is inserted in the lock at installation and then coupled to the digital lock and its turntail drive bar. This digital drive connector connects to the epicyclic gear train at a point where no gear ratio at all is given requiring only a small rotation of the digital lock knob or handle.

FIGS. 71 to 74 show all involved mechanism and relevant components with intermediate mechanism assemblies included to aid understanding.

FIGS. 75 to 78 show the improved lock 100 being set configured as manually driven and not latching. The key operation described herein will reflect this. Similar key and door handle use operates in a similar and equally effective manner if the lock is set as automatic latching.

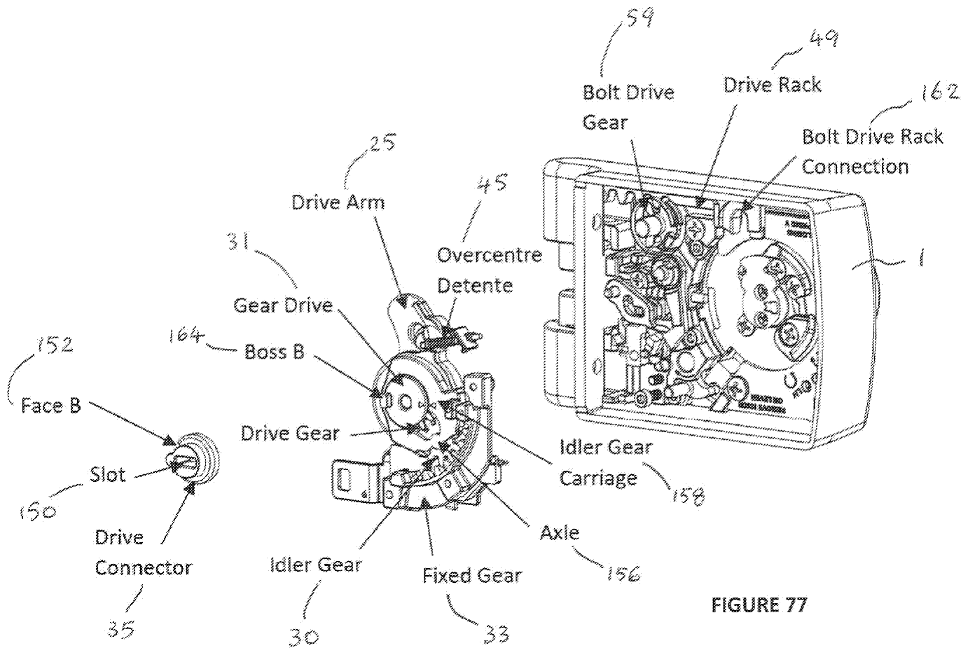

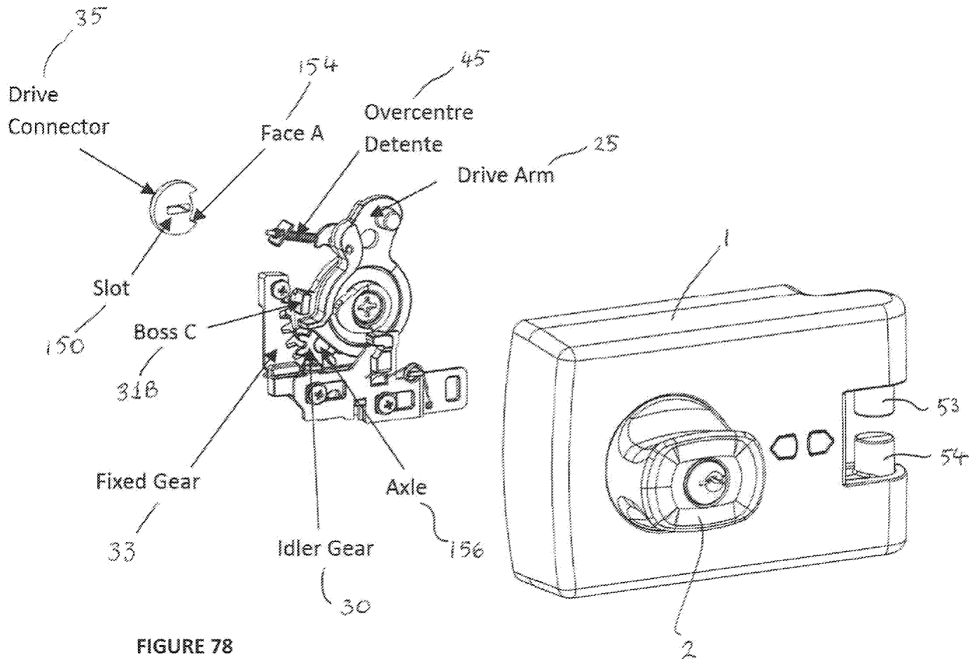

A description of the operation starts with FIGS. 77 and 78 showing the improved lock 100 at rest, the door (not shown) closed and latched with no external key in place. It will be appreciated that an external key is a key used from the outside of the door. The drive connector 35 operated by an external key sits at rest with slot 150 being horizontal and faces A and B 154 & 152 towards the bolt end of the lock 100.

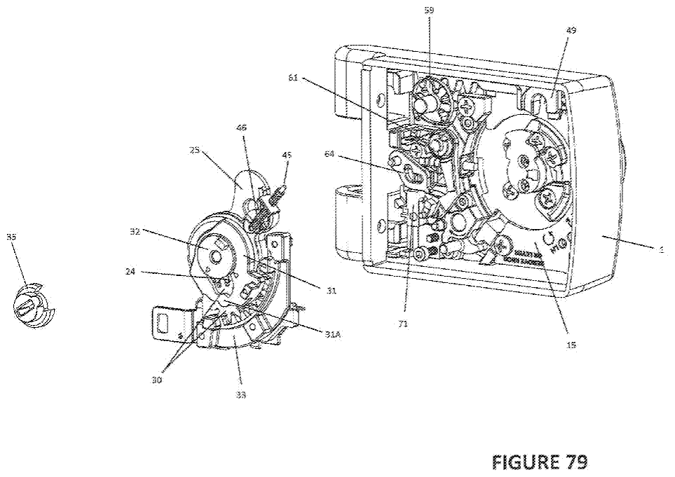

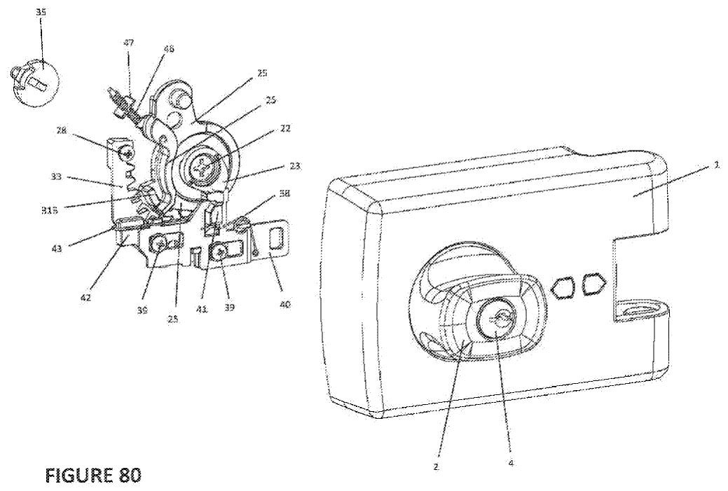

Referring to FIGS. 79 and 80, the lock is shown with bolts 53 & 54 fully retracted and the key (not shown) still rotated. An outside door key is used to retract the bolts 53 & 54 into the lock case 1 and unsecure the door (not shown). The key drives a cylinder with a turntail drive bar (all not shown) and the turntail drive bar inserted into drive connector slot 150 rotates the drive connector 35 in unison clockwise as shown in FIG. 79. The engagement of the drive connector 35 in turn urges gear drive 31 to also rotate clockwise by connection, which in turn rotates directly coupled drive gear 24 clockwise. An idler gear 30 is provided and connected as part of the epicyclic gear train. It operates between the drive gear 24 and the fixed gear 33 with the fixed gear 33 being an internal toothed curved gear rack. As such, as the drive gear 24 rotates clockwise (in the view shown in FIG. 79), the idler gear 30 rotates anticlockwise but travels clockwise around the inside of the fixed gear 33. The idler gear 30, which is mounted on an axle 156 (refer to FIG. 78) on the idler gear carriage 158 (see FIG. 75), drives the idler gear carriage 158 around in a clockwise direction. The idler gear carriage 158 connects to the drive arm 25 and also arm with boss C 31B (see FIG. 80 with the connection including lost motion). This results in the drive arm 25 also being driven clockwise. The drive arm 25 connects to the bolt drive rack connection and so the clockwise motion of the drive arm 25 withdraws the drive rack 49 to the right which in turn rotates the bolt drive gear 59 clockwise thereby retracting the bolts 53 & 54 into the case 1. During the motion of drive arm 25, an overcentre detent 45 has gone past its centre most compressed spring position and now urges the drive mechanism to stay as positioned until positively acted upon by the previous drive means again. When using the key and driving through this epicyclic gear train, the key turns approximately 200 degrees including lost motion rotation.

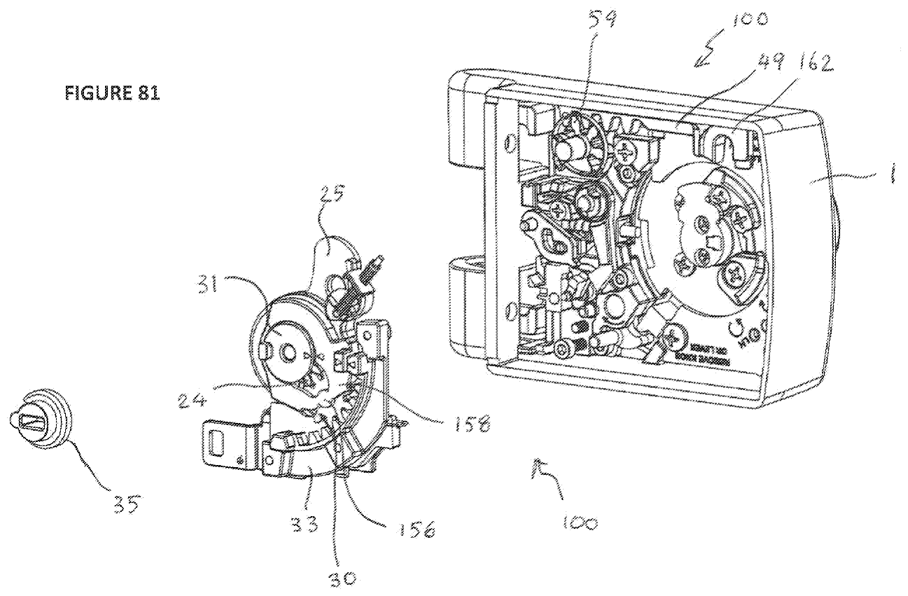

FIGS. 78 to 87 show the result of use of the outside door key again with cylinder and turntail drive bar (not shown) which are then able to be rotated anticlockwise as shown in FIG. 78 to allow the key to be removed but leaving the bolts 53 & 54 retracted. The turntail drive bar (not shown) inserted into the drive connector slot 150 rotates the drive connector 35 in unison anticlockwise as shown in the view shown in FIG. 81. The drive connector 35 in turn urges the gear drive 31 (see FIGS. 79 & 81) to also rotate anticlockwise by the connection, which again in turn rotates the directly coupled drive gear 24 anticlockwise. As the drive gear 24 rotates anticlockwise as shown in the view shown in FIG. 81, the idler gear 30 rotates clockwise but travels anticlockwise around the inside of the fixed gear 33. In so doing, the idler gear 30 which is mounted on the axle 156 on the idler gear carriage 158 drives the idler gear carriage 158 around in an anticlockwise direction. With the current component positioning and an anti-clockwise movement of the idler gear carriage 158, the idler gear carriage Boss C 31B can move with lost motion within the drive arm 25 without urging any motion in the drive arm 25 or any of its connected items, the drive rack 49, bolt drive gear 59 and the bolts 53 & 54. The key turns approximately 200 degrees including lost motion rotation.

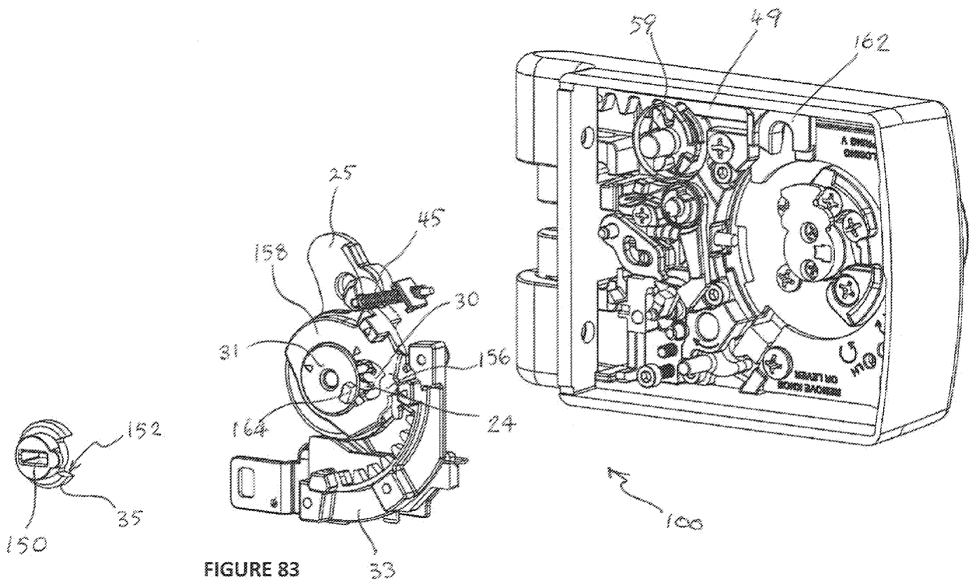

As shown in FIGS. 83 & 84, the bolts 53 & 54 are extended and deadbolted by the key (not shown) when the key is still rotated.

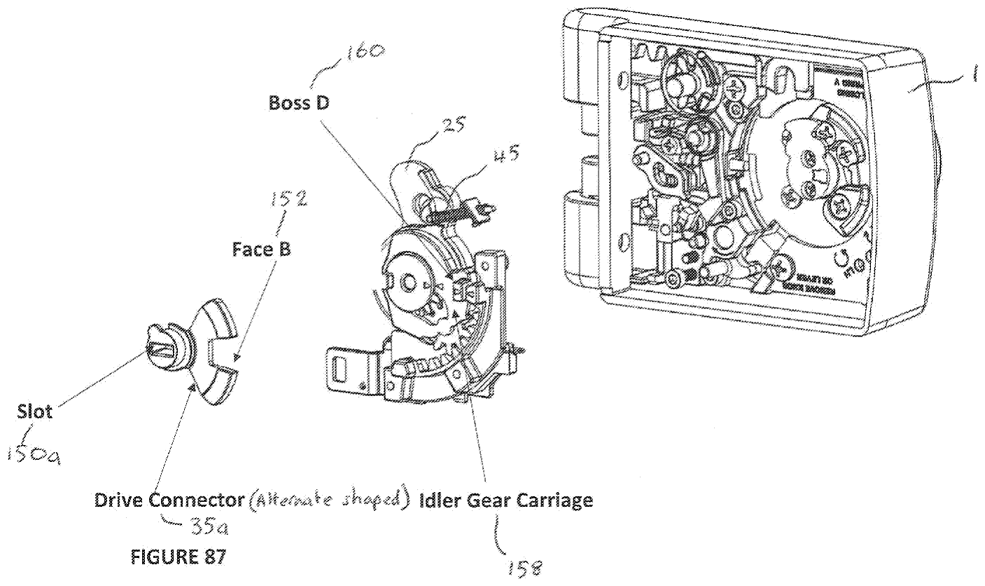

An outside door key (not shown) is used to extend the bolts 53 & 54 out of the lock case 1 and secure the door (not shown). The key drives a cylinder with turntail drive bar (all not shown) being inserted into the drive connector slot 150 which rotates the drive connector 35 in unison anticlockwise as shown in FIGS. 78 and 87. Drive connector Face B 152 in turn urges the gear drive 31 to also rotate anticlockwise by connection at Boss B 164 which in turn rotates the directly coupled drive gear 24 anticlockwise. Idler gear 30 is an idler gear 30 connected as part of an epicyclic gear train. It operates between the drive gear 24 and the fixed gear 33 with the fixed gear 33 being an internal toothed curved gear rack. So as the drive gear 24 rotates anticlockwise as shown in the view shown in FIG. 83, the idler gear 30 rotates clockwise but travels anti-clockwise around the inside of the fixed gear 33. In so doing, the idler gear 30 which is mounted on an axle on the idler gear carriage 158 drives the idler gear carriage 158 around in an anticlockwise direction. The idler gear carriage 158 connects to the drive arm 25 with Boss C 31B (the connection including lost motion) and so in turn the drive arm 25 also rotates anticlockwise. The drive arm 25 connects to the bolt drive rack connection 162 and so the anticlockwise motion of the drive arm 25 urges the drive rack 49 to the left in turn rotating the bolt drive gear 59 anticlockwise and extending the bolts out of the case 1. During the motion of the drive arm 25, the item overcentre detent 45 has gone past its centre most compressed spring position and now urges the drive mechanism to stay as positioned until positively acted on by the previous drive means again. When using the key (not shown) and driving through this epicyclic gear train, the key (not shown) turns approximately 200 degrees including lost motion rotation.

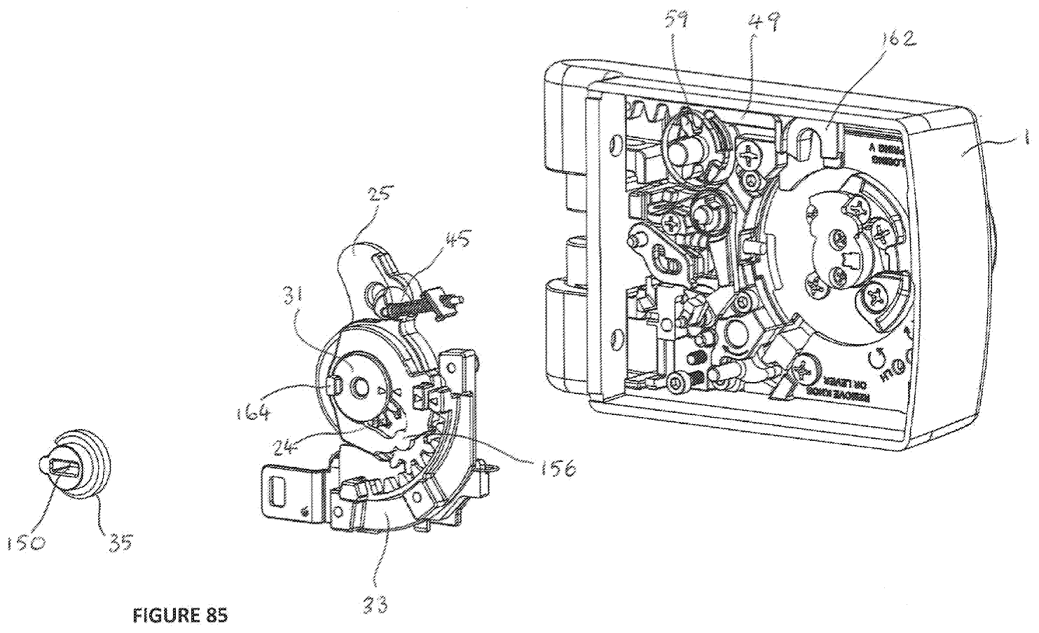

FIGS. 85 & 86 illustrate the bolts 53 & 54 being extended and deadbolted by the key (not shown) which is returned back central and removed.

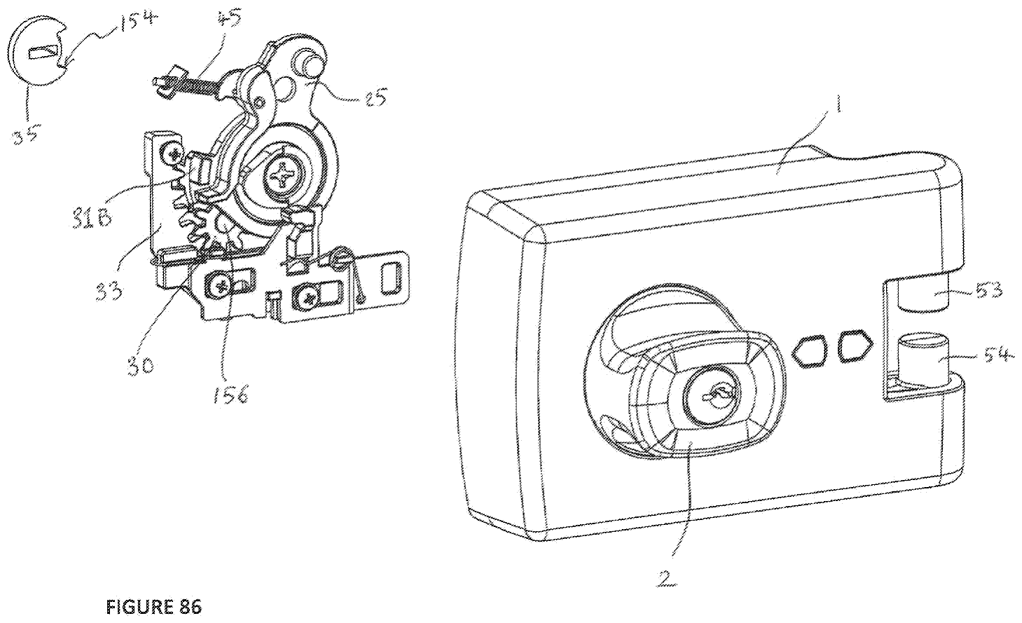

As shown in FIGS. 85 and 86, the outside door key again with cylinder and turntail drive bar (all not shown) are rotated clockwise as shown in FIG. 85 to allow the key to be removed but leaving the bolts retracted. The turntail drive bar inserted into the drive connector slot 150 rotates the drive connector 35 in unison clockwise as illustrated in the view shown in FIG. 85. The drive connector Face A 154 in turn urges the gear drive 31 to also rotate clockwise by connection at Boss B 164 again in turn rotating the directly coupled drive gear 24 clockwise. As the drive gear 24 rotates clockwise (as shown in the view shown in FIG. 85), the idler gear 30 rotates anticlockwise but travels clockwise around the inside of the fixed gear 33. In so doing, the idler gear 30 which is mounted on an axle 156 on the idler gear carriage 158 drives the idler gear carriage 158 around in a clockwise direction. With the current component positioning and a clockwise movement of the idler gear carriage 158, the idler gear carriage Boss C 31B can move with lost motion within the drive arm 25 without urging any motion in the drive arm 25 or any of its connected components including the drive rack 49, bolt drive gear 59 and the bolts 53 & 54. The key turns approximately 200 degrees including lost motion rotation.

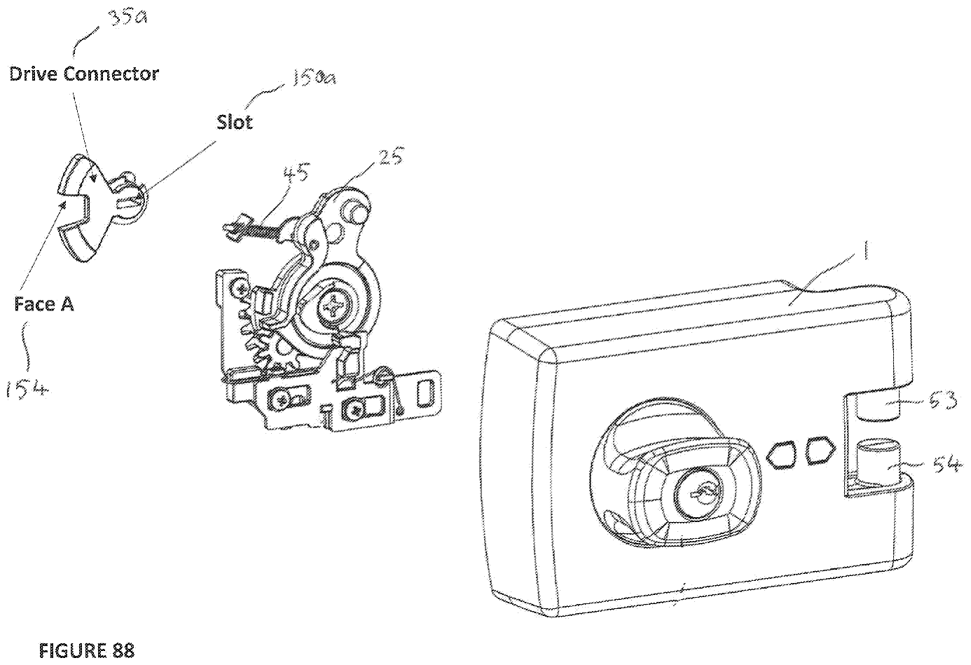

The lock of the present invention is alternatively installed with an alternate shaped drive connector 35a as shown FIGS. 87 to 96 to facilitate function with a digital lock with door handle or knob. FIGS. 87 and 88 show the lock at rest with the bolts 53 & 54 extended and door (not shown) deadbolted.

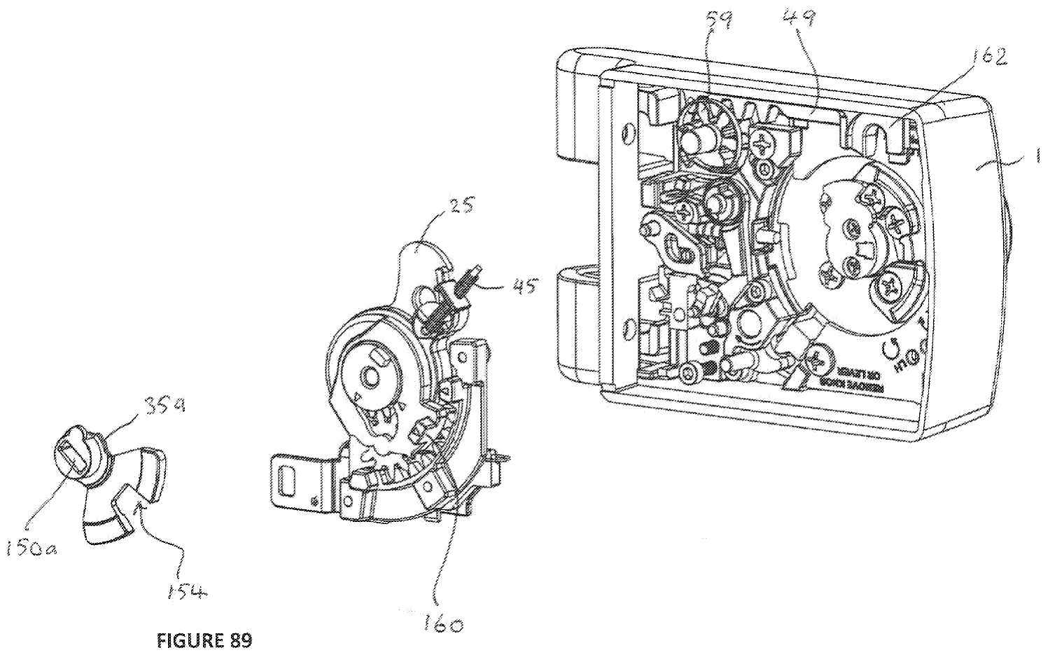

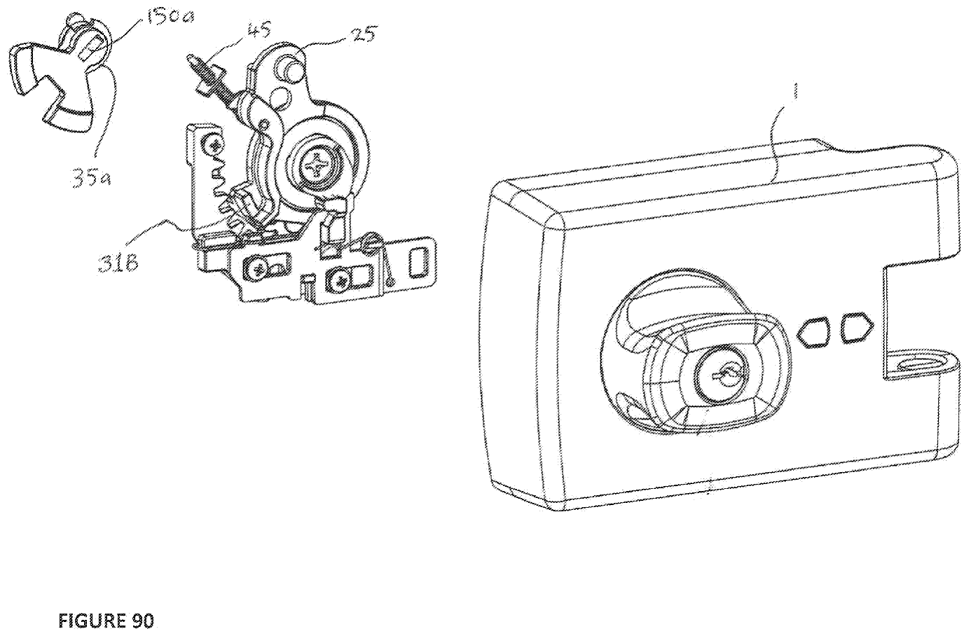

FIGS. 89 and 90 show a drive connector 35a that is coupled to an outside digital door lock with knob (not shown) used to retract the bolts 53 & 54 into the lock case 1 and unsecure the door are not shown. The outside digital lock drives a turntail drive bar (not shown) which is inserted into a digital drive connector slot 150a rotating the digital drive connector 35a in unison clockwise as shown in the view shown in FIG. 89. The digital drive connector Face A 154 in turn directly urges the idler gear carriage 158 around in a clockwise direction by acting on Boss D 160 and not having to act through any of the gear components. The idler gear carriage 158 connects to the drive arm 25 with Boss C 31B as shown in FIG. 89 (the connection including lost motion). This in turn drives the drive arm 25 also clockwise. The drive arm 25 connects to the bolt drive rack connection 162. As such, the clockwise motion of the drive arm 25 withdraws the drive rack 49 to the right in turn rotating the bolt drive gear 59 clockwise thereby retracting the bolts 53 & 54 into the case 1. During the motion of the drive arm 25, the overcentre detent 45 has gone past its centre, most compressed spring position and now urges the drive mechanism to stay as positioned until positively acted upon by the previous drive means again. When using the digital door lock knob (or handle), direct driving of the idler gear carriage 158 is effected without going through the epicyclic gear train resulting in the knob (or handle) turning approximately 45 degrees including the lost motion rotation.

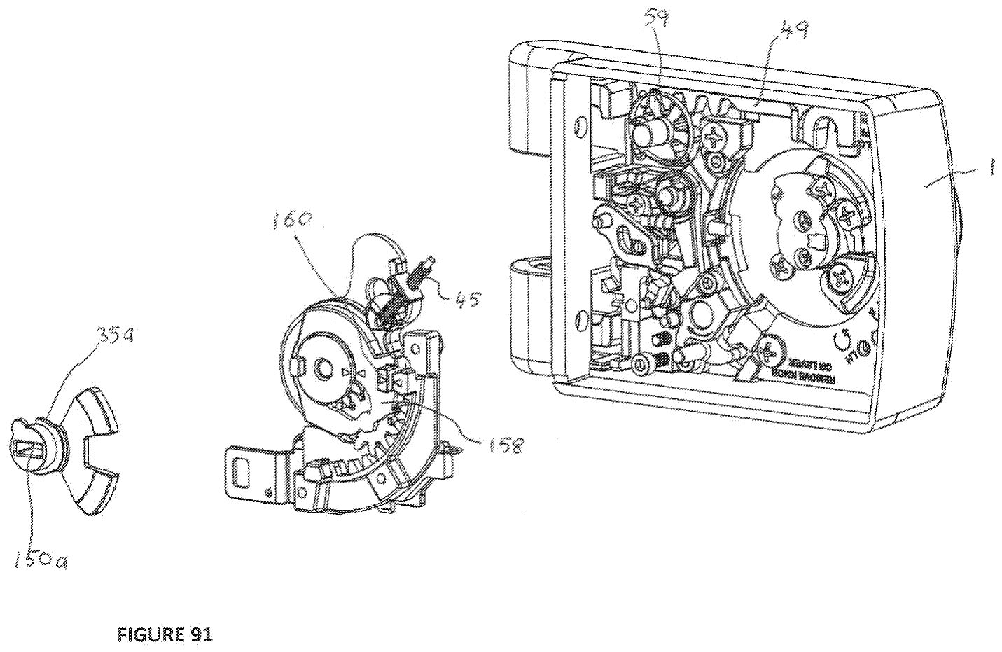

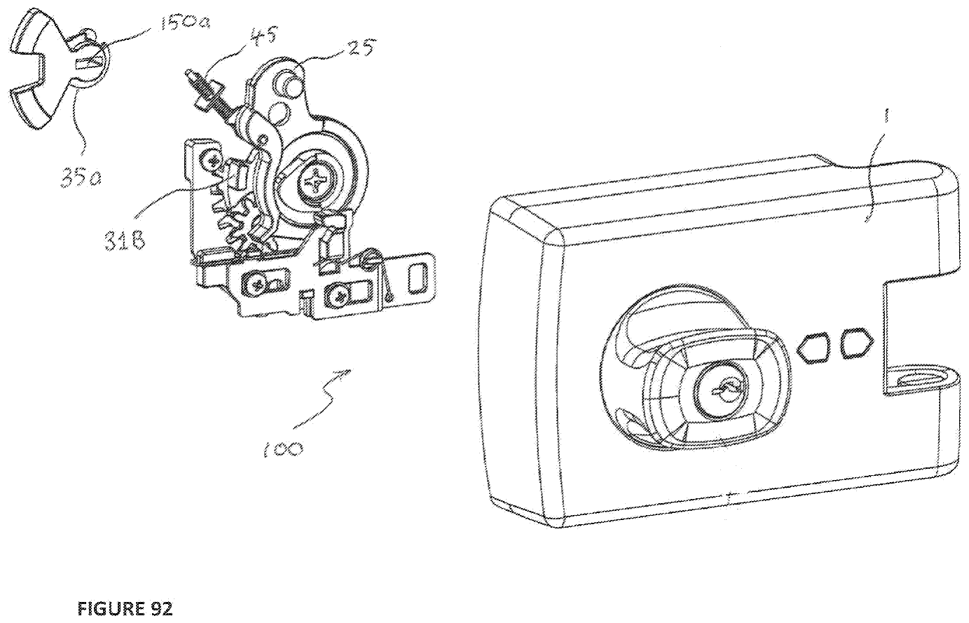

Turning now to FIGS. 91 and 92, the drive connector 35a is shown being re-centred. The knob of the outside digital door lock with the turntail drive bar (not shown) is released to rotate anticlockwise being urged by the charged knob (or handle) spring located within the digital lock. As the turntail drive bar is mated in the digital drive connector slot 150a, the digital drive connector 35a also rotates in unison anticlockwise, as shown in the view shown in FIG. 91. The digital drive connector Face B 152 in turn directly urges the idler gear carriage 158 around in an anticlockwise direction by acting on Boss D 160 but not having to act through any of the gear components. With the current component positioning and an anti-clockwise movement of idler gear carriage 158, idler gear carriage Boss C 31B can move with lost motion within the drive arm 25 without urging any motion in the drive arm 25 or any of its connected components such as the drive rack 49, bolt drive gear 59 and the bolts 53 & 54. The digital lock knob (or handle) then turns approximately 45 degrees including lost motion rotation.

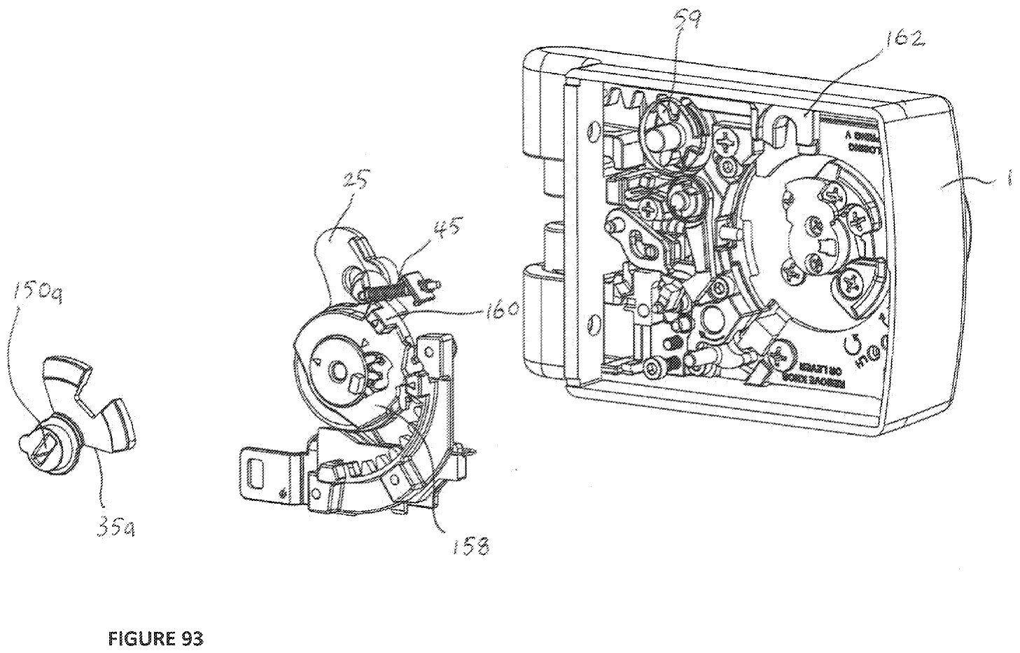

An outside digital door lock with the knob (or handle) is used to extend the bolts 53 & 54 back out from the lock case 1 and secure the door (not shown). The digital knob (or handle) is turned anticlockwise as shown in FIG. 93 so as to charge the knob (or handle) return spring located inside the digital lock. The lock drives a turntail drive bar (not shown) which is inserted into the digital drive connector slot 150a and rotates the digital drive connector 35a in unison anticlockwise as shown in the view shown in FIG. 93. The digital drive connector Face B 152 in turn directly urges the idler gear carriage 158 around in an anticlockwise direction by acting on Boss D 160 and not having to act through any of the gear components. The idler gear carriage 158 connects to the drive arm 25 with Boss C 31B (the connection including lost motion) and so in turn drives the drive arm 25 also anticlockwise. The drive arm 25 connects to the bolt drive rack connection 162. As such, the anticlockwise motion of the drive arm 25 urges the drive rack 49 to the left. This results in rotating the bolt drive gear 59 anticlockwise and extending the bolts 53 & 54 out from the case 1. During the motion of the drive arm 25, the overcentre detent 45 has gone past its centre most compressed spring position and now urges the drive mechanism to stay as positioned until positively acted upon by the previous drive means again. When using the digital door lock knob (or handle), direct driving of the idler gear carriage 158 is effected without going through the epicyclic gear train resulting in the knob (or handle) turning approximately 45 degrees including lost motion rotation.

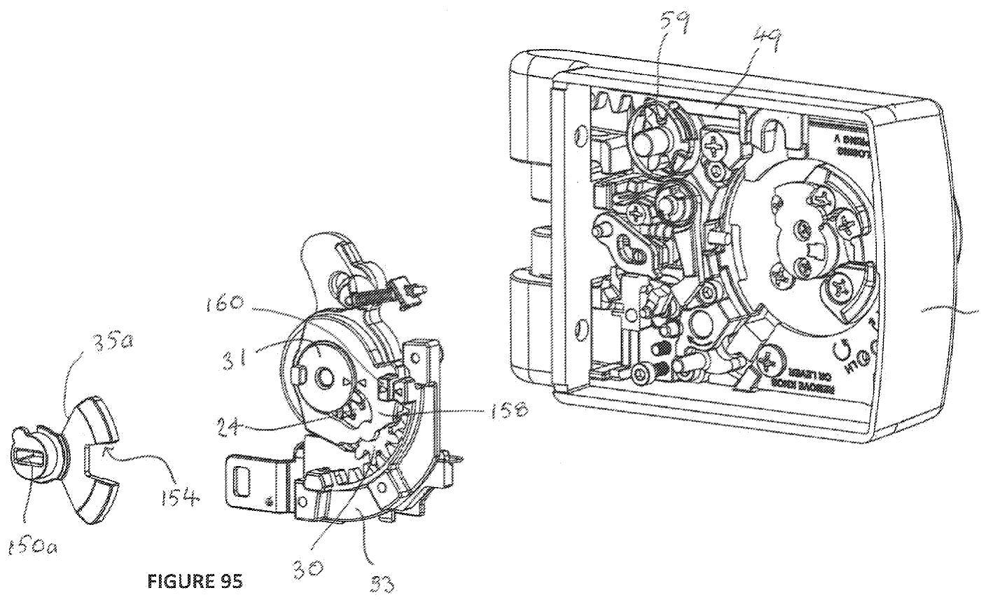

FIGS. 95 & 96 show the drive connector 35a being re-centred. The knob of the outside digital door lock with the turntail drive bar (not shown) is released to rotate clockwise, being urged by the charged knob (or handle) spring located within the digital lock. As the turntail drive bar is mated in the digital drive connector slot 150a, the digital drive connector 35a also rotates in unison clockwise as shown in the view shown in FIG. 95. The digital drive connector Face A 154 in turn directly urges the idler gear carriage 158 around in a clockwise direction by acting on Boss D 160 and not having to act through any of the gear components. With the current component positioning and an anticlockwise movement of idler gear carriage 158, idler gear carriage Boss C 31B can move with lost motion within the drive arm 25 without urging any motion in the drive arm 25 or any of its connected components including the drive rack 49, bolt drive gear 59 and the bolts 53 & 54. The digital lock knob (or handle) then turns approximately 45 degrees including lost motion rotation.

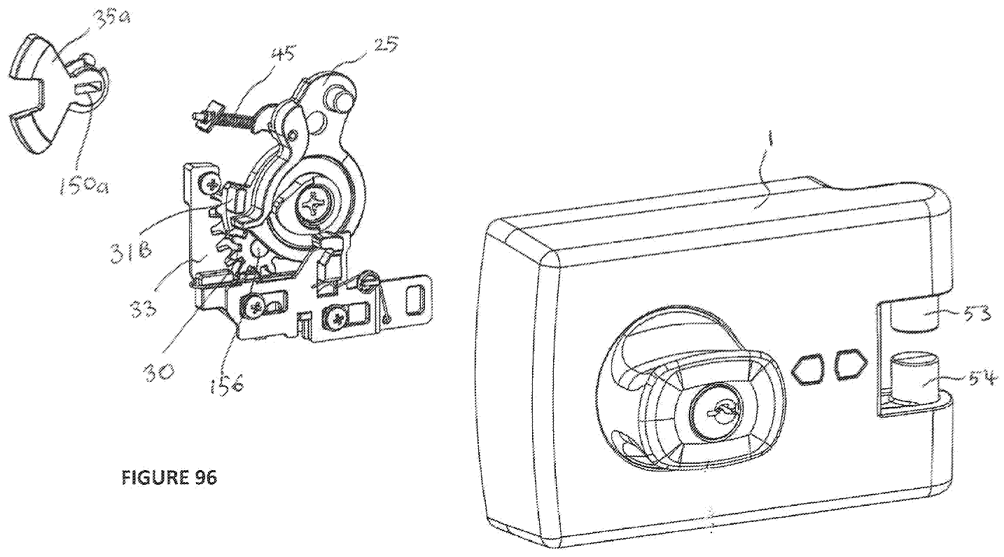

FIG. 96 shows the bolts 53 & 54 being sufficiently extended and deadbolted while the digital lock knob (or handle) is re-centred.

### Improvement 6—Successful Lock Bolt Throw Indication

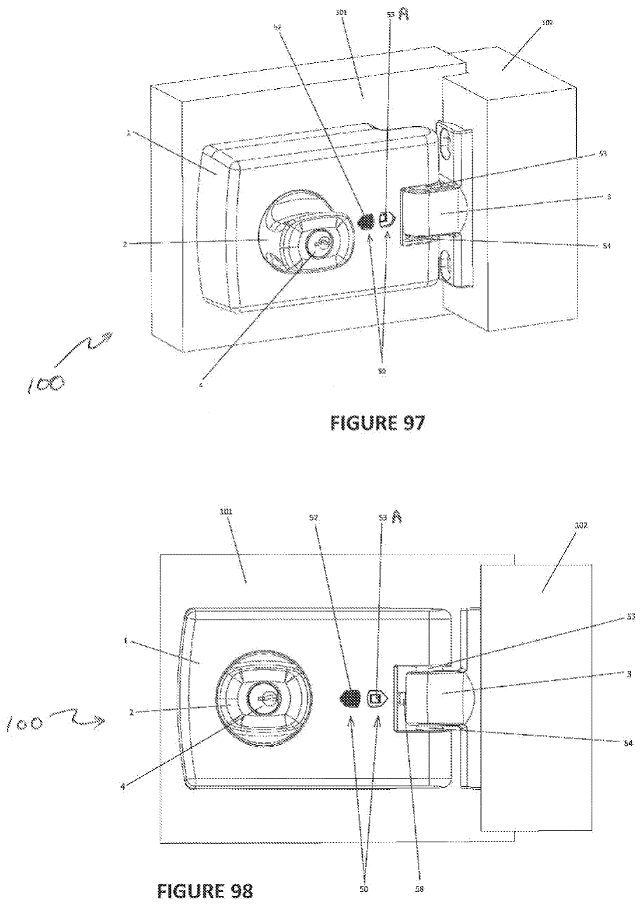

Referring to FIGS. 97 to 102, there is shown a still further improvement of providing an indicator 53A on a latching jimmy proof deadbolting high security lock 100 such that a user can be assured the bolt has been sufficiently thrown and is thereby deadbolted.

In particular, the deadbolting latching lock is designed to have the deadbolt(s) sprung into its strike. The spring might not have sufficiently thrown the bolt(s) into the strike. Deadbolting only happens when the bolt(s) is/are sufficiently thrown.

The benefit of this new improvement is that the user has specific easily read indicated assurance that the bolt(s) is/are sufficiently thrown thereby offering ease of use with peace of mind.

To achieve this, the lock 100 includes at least one bolt moveable between a sufficiently engaged position with an associated strike to secure a door and a fully disengaged position when the door is not secured. The closing spring member 48 is provided and associated with the bolt and strike in such a way that the closing spring member 48 is capable of urging the bolt to move to the engaged position. An opening means is provided for moving the bolt to a fully disengaged position against the closing spring member 48 so as to unsecure the door to allow opening. The indication means is associated with the bolt and provided to show whether the bolt has sufficiently moved into the engaged position and is therefore secured.

The door closing sensor button 58 can react to the approach of the associated strike 3 and release the bolt 53, 54 from the latched fully disengaged position, so that its associated closing spring member 48 returns the bolt to its engaged position and secures the door.

The bolt is a deadbolt moveable to an engaged and deadbolted position with an associated strike to secure a door. The closing spring member 48 is designed to tend the deadbolt to move to the engaged and deadbolted position. The lock further includes a means of latching the deadbolt in the fully disengaged position against the closing spring member 48 to unsecure the door to allow opening.

The door closing sensor button 58 senses and reacts to the approach of the associated strike and releases the deadbolt from the latched fully disengaged position, wherein its associated closing spring member 48 returns the deadbolt to its engaged and deadbolted position and secures the door. The indication means indicates that the deadbolt has sufficiently moved into the engaged and deadbolted position.

As shown in FIGS. 97 to 102, it can be seen that the improvement uses two opposing sliding bolts 53 & 54 in the lock 100 and the actuating bar for one has a locked indication symbol printed on it, this can be by colour with a red and green indication for example, red for locked and green (or an alternative identifiable colour) for unlocked. When that the bolts are sufficiently thrown, the locked symbol appears opposite an indication window on the front of the lock case 1, being easily visible to a user.

Knowing that a lock or latchbolt is sufficiently thrown into its associated strike gives reassurance that the bolt(s) is/are deadlocked (which preferably happens near the end of the bolt throw) and the door is secure. There are however not many products on the market that give a user any indication that the bolt is sufficiently thrown. Many locks have indication that the lock condition is locked or unlocked—but this only indicates that if locked, the bolt cannot be withdrawn from the strike by say someone from outside the door using a handle only without also having a key. However, it does not show how far into the strike the bolt has travelled or if deadlocking has actually occurred. If the door and frame alignment changes causing the locking bolt(s) to not sufficiently enter the strike, this will be shown by the status of the indicator.

With the latching anti-jimmy deadbolt described herein, being a high security item and relying on a spring to urge the bolt into the strike, also included is a means to know or reflect that the bolt has sufficiently entered the strike as a user may well want to be assured of this. This does raise the possibility of more universal application of this sort of feature—for locks of all sorts including deadbolts and latchbolt locks and then also even into latching products such as internal door latches with external lockable handles. This indication application can also be used with locking bolt(s) that do not have deadlatching and deadbolting mechanisms.

Referring to the drawings, there is shown in FIG. 97 a general isometric view of a lock 100 on a door 101 engaged with the strike 3 on a door jamb 102. There is provided an—indication through a bolt throw indicator 53A showing that bolts 53 & 54 are sufficiently thrown.
Referring to FIG. 98, there is shown a general front view of the lock 100 on closed door 101 with the bolts 53 & 54 thrown and engaged with the strike 3 on door jamb 102. There is provided an indication through the bolt throw indicator 53A showing that the bolts 53 & 54 are sufficiently thrown. The bolt throw indicator 53A is in the form of a pair of indication windows 50.

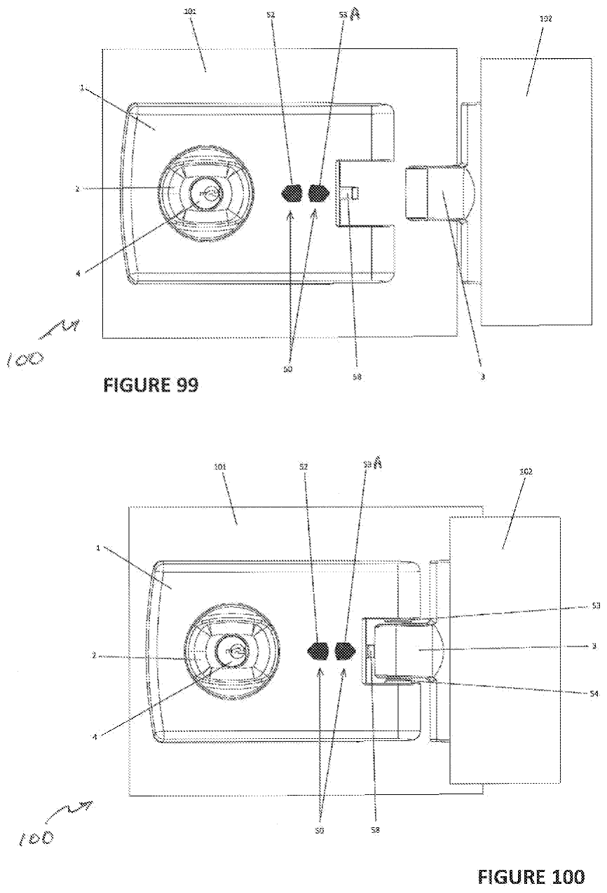

Referring to FIG. 99, the bolts 53 & 54 are fully retracted and latched open and ready to shut being urged by a closing spring (not shown). The indicator 53A is showing the bolts 53 & 54 being open, the door being ajar and the door closing sensor being extended and ready to interact with the approaching strike.

Turning now to FIG. 100, the door 101 is shut but not yet secure. It can been seen that the bolts 53 & 54 are extended some way but not yet within the strike 3. The strike 3 is pushing the door closing sensor 58 thereby releasing the bolts without any change of indication. The door 101 has now shut and the door closing sensor 58 has been pushed into the lock case 1 resulting in releasing of the spring-loaded bolts 53 & 54 which have extended a small distance but have not yet entered the strike 3. The bolt throw indication has not yet changed from showing the bolts 53 & 54 are retracted.

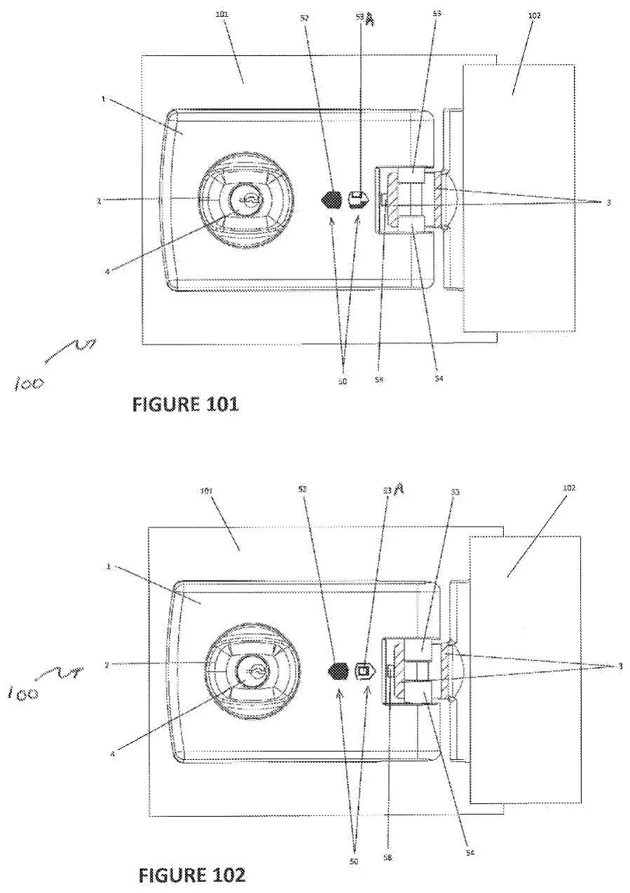

Referring to FIG. 101, the door 101 is now shut and secure with the bolts 53 & 54 extending partly within the strike 3. with the indicator 53A half showing the door 3 is shut, the spring-loaded bolts being released and continuing to extend and enter the strike 3. The bolt throw indication has partly changed showing the bolts 53 & 54 are part way engaged in the strike 3.

FIG. 102 shows that the door 101 is shut and secure with the bolts 53 & 54 being extended sufficiently within the strike 3. The indicator 53A is fully showing centred in the window, being indicative of the fact that the bolts 53 & 54 are sufficiently engaged.

In a direct drive form, the lock 100 includes one or two bolt(s) moveable between an engaged position with an associated strike 3 to secure a door and a disengaged position when the door is not secured. The direct drive is associated with the bolt(s) 53, 54 wherein selective operation of the direct drive moves the bolt(s) 53, 54 to move to an engaged position or moves the bolt(s) 53, 54 to a disengaged position to unsecure the door 101 to allow opening. The indication means, being in the form of the bolt throw indicator 53A in this embodiment, is associated with the bolt(s) 53, 54 and provided to show whether the bolt(s) 53, 54 has/have sufficiently moved into engaged position and is/are therefore secured.

Other forms would be understood by a skilled addressee.

### Interpretation

Definitions—throughout this document, the terms will have the following inclusive meanings:
‘Deadbolt” means deadbolt is positively locked into position when it has sufficiently entered their strike and includes particularly the form of a vertical deadbolt in which pins extend at substantially right angle into at least substantially surrounding enclosing pin surrounds integrally extending from a strike plate mounted to the door frame;
“Latching” in one form, means the bolt or bolts are sprung, can be retained in a latched retracted position, and fire out to secure a door when activated by a trigger impacting with the strike; and
“Deadlocks” and “deadbolts” both need a key to lock but a deadlock can only be unlocked in deadlock mode with a key, deadbolts can be locked and unlocked with a key and have a metal lock that extends from the door into a strike mounted on the wall; “Deadlatches” are the types of locks that can automatically lock themselves once you close the door; this invention is primarily aimed at “latching deadbolts” and means and variations thereof. Also, it is important to note that deadbolts can also be locked and unlocked by a snib on the inside.
“Operator” and “actuating member” are to be understood as interchangeable throughout the specification referring to the same component, which may be a mechanical or digital knob or lever.
“External actuator” is intended to refer to an actuator that is located on and operated from the outside of the door.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the lock industries.

1-29. (canceled)

30. A lock for interacting with a strike having a part enclosing ring, the lock including:
a. a case,
b. at least one moveable bolt linearly and slidably mounted in the case and interactive within the strike having the part enclosing ring and providing relative linear motion to protrude into a lock space;
c. a closing resilient member urging the at least one moveable bolt to protrude from the case into the lock space to a door secured position within the part enclosing ring of the strike;
d. an operator engaging the at least one moveable bolt with a rotation of the operator causing relative linear motion of the at least one moveable bolt to substantially withdraw bolts from the lock space;
e. a latching member positioned to engage a rotating member in a latched position when the rotating member is so rotated to withdraw the at least one moveable bolt from the lock space to a door unsecured position; and
f. a door closing sensor button which senses a relative location of the strike and drives the latching member to unlatch the rotating member allowing the closing resilient member to return the at least one moveable bolt to protrude into the lock space to the door secured position within the part enclosing ring of the strike.

31. The lock according to claim 30 wherein the at least one moveable bolt is a pair of opposingly moveable bolts co-linearly and slidably mounted therein providing relative linear motion to protrude into the lock space from opposing sections of the case and wherein the closing resilient member is adapted to urge the bolts relatively towards or away from each other.

32. The lock according to claim 31 wherein the pair of opposingly moveable bolts co-linearly and slidably mounted therein provide relative linear motion to protrude into the lock space from opposing sections of the case and wherein the closing resilient member is adapted to urge the bolts to protrude in a pincer movement from the opposing sections of the case into the lock space to the door secured position within the part enclosing ring of the strike.

33. The lock according to claim 30 wherein the door closing sensor button includes a mechanical engaging sensor.

34. The lock according to claim 30 wherein the door closing sensor button includes a sloped engaging surface extending into the lock space wherein a relative location of the strike is physically engaged.

35. The lock according to claim 30 wherein the door closing sensor button includes an electronic engaging sensor.

36. The lock according to claim 30 wherein the door closing sensor button includes a positional sensor sensing a relative location of the strike extending into the lock space.

37. The lock according to claim 30 wherein the operator includes a keyed rotatable knob.

38. The lock according to claim 30, wherein the case has a main box like portion and at least one overhang intersecting through a linear alignment of a movement of the at least one moveable bolt thereby providing at least partially restricted lock space preventing access to an end of the at least one moveable bolt.

39. The lock according to claim 30, wherein the case has a main box which interacts with the strike that has at least one overhang intersecting through the linear alignment of the movement of the at least one moveable bolt to thereby form an at least partially restricted lock space preventing access to an end of the at least one moveable bolt.

40. The lock according to claim 30 wherein the case comprises a main box like portion and the case further includes two latch member opposing sections extending from one side in a substantially C-shape forming the lock space therebetween and wherein the door closing sensor button is so positioned and shaped to protrude and can interact with an associated strike, wherein the strike approaches by one direction of:
a. from a first side of the C-shape formed by the latch member opposing sections
b. from a second side of the C-shape formed by the latch member opposing sections
c. from an inline end position into the C-shape formed by the latch member opposing sections; and
wherein the lock can equally work when the strike approaches from any of three door operating directions including:
d. hingedly opening inwards,
e. hingedly open outwards, and
f. sliding in parallel plane.

41. The lock according to claim 40 wherein the door closing sensor button includes:
a. a first surface for effecting a latching movement into the main box like portion of the lock when engaged by the strike from the first side of the C-shape formed by the two latch member opposing sections;
b. a second surface opposed to the first surface for effecting a latching movement into the main box like portion of the lock when engaged by the strike from the second side of the C-shape formed by the two latch member opposing sections; and
c. an end surface for effecting a latching movement into the main box like portion of the lock when engaged by the strike from the inline end position into the C-shape formed by the two latch member opposing sections.

42. The lock according to claim 30, wherein
a. the latching member retains the rotating member in a latched position when the rotating member is rotated to withdraw the bolts from the lock space to the door unsecured position; and
b. the rotating member interacts with the latching member when the door closing sensor button senses the strike and which can unlatch the rotating member allowing the bolt to return to the door secured position when the door closing sensor senses a motion of the door being closed.

43. The lock of claim 42, wherein
a. the door closing sensor button is depressible by the strike and which can interact with the latching member to unlatch the bolt allowing return of the bolt to the door secured position; and
b. an interaction of the door closing sensor button is such that the door closing sensor button only interacts with the latching member when the door closing sensor button is in motion being depressed.

44. The lock of claim 30 wherein the lock has at least two forms including:
a. at least one slidably mounted bolt therein, the at least one slidably mounted bolt being positionable within an associated strike to secure the door and the at least one slidably mounted bolt also being positionably withdrawn from the associated strike to leave the door unsecured;
b. an actuating member facilitating movement of the at least one slidably mounted bolt;
c. wherein a connection between the actuating member and the at least one slidably mounted bolt is alterable between two forms;
i. wherein in a first form a movement and position of the at least one slidably mounted bolt is purely adjusted by operation of the actuating member; and
ii. wherein in a second form a movement of the at least one slidably mounted bolt to a withdrawn position is achieved through operation of the actuating member but movement of the at least one slidably mounted bolt into a door secured position is achieved without a need for input from the actuating member.

45. The lock according to claim 44, wherein in the first form the actuating member includes the rotating member and engages at least one bolt and the rotating member is disengaged from the latching member and a spring member with a rotation of the actuating member causing relative linear motion of the at least one slidably mounted bolt to substantially withdraw the at least one slidably mounted bolt from the lock space and with a rotation of the actuating member causing relative linear motion of the at least one slidably mounted bolt to substantially extend the at least one slidably mounted bolt into the lock space; and wherein in the second form the actuating member includes the rotating member and a closing spring member engages the at least one slidably mounted bolt with a rotation of the actuating member causing relative linear motion of the bolts to substantially withdraw the at least one slidably mounted bolt from the lock space and the closing spring member to substantially extend the at least one slidably mounted bolt into the lock space to effect locking.

46. The lock according to claim 30, wherein the lock includes an actuator for actuating a bolt driving mechanism having a gear drive mechanism that connects with the rotating member engaging the at least one moveable bolt and allowing for a geared ratio between the actuator and the rotating member.

47. The lock according to claim 46, wherein the lock includes at least one external actuator lock selected from the group consisting of a key lock and a digital lock and wherein the key lock or the digital lock engages with the rotating member engaging the at least one moveable bolt with a rotation of the rotating member causing relative linear motion of the at least one moveable bolt to substantially withdraw the at least one moveable bolt from the lock space.

48. The lock according to claim 46, wherein the bolt driving mechanism engages with a turntail drive bar for driving the at least one moveable bolt to substantially extend or withdraw from the lock space.

49. The lock according to claim 46, wherein the gear drive mechanism includes an epicyclic gear train giving a high gear ratio and so requiring a substantial reduction in driving force of the actuating member while similarly reducing a key force required to operate the lock.

50. The lock according to claim 49, wherein the bolt driving mechanism is selectively engageable with a selected one of a key lock or a digital lock.

51. The lock according to claim 50, wherein the bolt driving mechanism includes:
a. the gear drive mechanism connecting with the bolt driving mechanism;
b. the gear drive mechanism including a gear train and having at least two selectable actuator connection points;
c. where one actuator connection point allows the actuator to drive the bolt driving mechanism directly for a particular function bypassing the gear train; and
d. at least one other actuator connection point allowing the actuator to drive the bolt driving mechanism through the gear train thereby changing a number of turns required of the actuator to operate the bolt drive mechanism to achieve a particular function.

52. The lock according to claim 51, wherein the bolt driving mechanism includes the rotating member engaging at least one of the bolts with a rotation of the rotating member causing relative linear motion of the bolts to substantially withdraw the bolts from the lock space.

53. A lock comprising;
a. a bolt moveable between an engaged position with an associated strike to secure a door and a disengaged position when the door is not secured;
b. a spring member associated with a bolt wherein a spring member urges the bolt to move to an engaged position;
c. an opening means for moving the bolt to the disengaged position against the spring member to unsecure the door to allow opening; and
d. an indication means associated with the bolt and provided to show whether the bolt has sufficiently moved into the engaged position and is therefore secured.

54. The lock according to claim 53 further comprising:
a door closing sensor button that can react to an approach of the associated strike and release the bolt from a latched disengaged position, so that an associated spring member returns the bolt to the engaged position and secures the door.

55. The lock according to claim 53, wherein the bolt is moveable to the engaged position and a deadbolted position with the associated strike to secure the door and the spring member urging the bolt to the engaged and deadbolted positions; and
the lock further including a means of latching the bolt in the disengaged position against the spring member to unsecure the door to allow opening.

56. The lock according to claim 55, further comprising:
a door closing sensor button that senses and reacts to an approach of the associated strike and releases the bolt from the disengaged position, wherein the spring member returns the bolt to the engaged and deadbolted positions and secures the door and wherein the indication means indicates that the bolt has sufficiently moved into the engaged and deadbolted positions.

57. The lock according to claim 56 in wherein an indication that the bolt has sufficiently moved into the engaged and deadbolted positions comes from a position of the bolt.

58. A lock including:
a. a bolt moveable between an engaged position with an associated strike to secure a door and a disengaged position when the door is not secured;
b. a direct drive associated with the bolt wherein selective operation of the direct drive moves the bolt to move to the engaged position or moves the bolt to the disengaged position to unsecure the door to allow opening; and
c. an indication means associated with the bolt and provided to show whether the bolt has sufficiently moved into engaged position and is therefore secured.
